(19) United States
(12) Patent Application Publication
(10) Pub. No.: US 2026/0268138 A1
(43) Pub. Date: Sep. 10, 2026

(54) ARTIFICIAL INTELLIGENCE-BASED TEXT-TO-IMAGE GENERATION MODEL TRAINING METHOD AND IMAGE GENERATION METHOD

(71) Applicant: Tencent Technology (Shenzhen) Company Limited, Shenzhen (CN)

(72) Inventors: Sibo LIU, Shenzhen (CN); Hu YE, Shenzhen (CN); Jun ZHANG, Shenzhen (CN)

(73) Assignee: Tencent Technology (Shenzhen) Company Limited, Shenzhen (CN)

(21) Appl. No.: 19/660,548

(22) Filed: Apr. 28, 2026

Related U.S. Application Data
(63) Continuation of application No. PCT/CN2025/077612, filed on Feb. 17, 2025.

(30) Foreign Application Priority Data
Feb. 20, 2024 (CN) 202410189093.0

(51) Int. Cl. G06N 3/08; G06T 11/00; G06V 30/146; G06V 30/18

(52) U.S. Cl. CPC G06N 3/08; G06T 11/00; G06V 30/146; G06V 30/18

(57) ABSTRACT

An artificial intelligence-based text-to-image generation model training method, apparatus, and computer-readable storage medium for cross-modal learning. The method obtains sample images and extracts first image features from them. These first image features are aligned into a text feature space to obtain second image features representing the sample images in text-aligned form. Images are generated based on these second image features to produce prediction results. A text-to-image generation model is trained using these prediction results, enabling the model to learn cross-modal relationships between text and image domains through feature space alignment, facilitating effective text-to-image generation capabilities.

### CROSS-REFERENCE TO RELATED APPLICATIONS

This application is a continuation application of International Application No. PCT/CN2025/077612 filed on February 17, 2025 which claims priority to Chinese Patent Application No. 202410189093.0, filed with the China National Intellectual Property Administration on February 20, 2024, the disclosures of each being incorporated by reference herein in their entireties.

### FIELD

The disclosure relates to the technical field of artificial intelligence (AI), an AI-based text-to-image generation model training method, and image generation method and apparatus, an electronic device, a computer-readable storage medium, and a computer program product.

### BACKGROUND

Text-to-image generation is a main direction of artificial intelligence generated content (AIGC), and is one of the most potential and promising research directions in the field of AI currently. A text-to-image generation model can assist human in creating content by converting text descriptions into images, and is widely applied to various application scenarios such as concept art design.

In the related art, a large quantity of image-text pairs are usually used to train a text-to-image generation model, and a model training effect highly depends on quality of the image-text pairs. However, in practice, quality of text annotations in the image-text pairs may be low, leading to a poor training effect of the text-to-image generation model, and a poor image generation effect of a trained text-to-image generation model.

### SUMMARY

Provided are an artificial intelligence (AI)-based text-to-image generation model training method and apparatus, a device, a storage medium, and a program product, which can implement effective text-to-image generation model training through image feature extraction and cross-modal feature space alignment.

According to some embodiments, an artificial intelligence (AI)-based text-to-image generation model training method, performed by a computer device, includes: obtaining a sample image; extracting a first image feature from the sample image; aligning the first image feature into a text feature space to obtain a second image feature of the sample image; generating an image based on the second image feature, to obtain a prediction result; and training a text-to-image generation model based on the prediction result.

According to some embodiments, an artificial intelligence (AI)-based text-to-image generation model training apparatus, includes: at least one memory configured to store program code; and at least one processor configured to read the program code and operate as instructed by the program code, the program code including: obtaining code configured to cause at least one of the at least one processor to obtain a sample image; extracting code configured to cause at least one of the at least one processor to extract a first image feature from the sample image; aligning code configured to cause at least one of the at least one processor to align the first image feature into a text feature space to obtain a second image feature of the sample image; generating code configured to cause at least one of the at least one processor to generate an image based on the second image feature, to obtain a prediction result; and training code configured to cause at least one of the at least one processor to train a text-to-image generation model based on the prediction result.

According to some embodiments, a non-transitory computer-readable storage medium, storing computer code which, when executed by at least one processor, causes the at least one processor to at least: obtain a sample image; extract a first image feature from the sample image; align the first image feature into a text feature space to obtain a second image feature of the sample image; generate an image based on the second image feature, to obtain a prediction result; and train a text-to-image generation model based on the prediction result.

### BRIEF DESCRIPTION OF THE DRAWINGS

To describe the technical solutions in some embodiments or in the related art more clearly, the following briefly describes the accompanying drawings required for describing the embodiments or the related art. Apparently, the accompanying drawings in the following descriptions show merely embodiments of this application, and a person of skill in the art may still derive other accompanying drawings from the disclosed accompanying drawings without creative efforts.

FIG. 1 is a schematic architectural diagram of an artificial intelligence (AI)-based image generation system according to some embodiments.

FIG. 2 is a schematic structural diagram of a server according to some embodiments.

FIG. 3 is a schematic structural diagram of a terminal device according to some embodiments.

FIG. 4 is a first schematic flowchart of an AI-based text-to-image generation model training method according to some embodiments.

FIG. 5 is a schematic diagram of training a multi-modal model according to some embodiments.

FIG. 6 is a schematic flowchart of an AI-based image generation method according to some embodiments.

FIG. 7A is a schematic comparison diagram of style binding according to some embodiments.

FIG. 7B is a schematic comparison diagram of object binding according to some embodiments.

FIG. 8 is a schematic flowchart of training a LoRA model according to some embodiments.

FIG. 9 is a schematic diagram of training an alignment network according to some embodiments.

FIG. 10 is a schematic diagram of training an embedded image feature according to some embodiments.

FIG. 11 is a schematic diagram of training a LoRA model according to some embodiments.

FIG. 12 is a schematic diagram of outputting a target image for a prompt image according to some embodiments.

FIG. 13 is a schematic diagram of outputting a target image for prompt text according to some embodiments.

FIG. 14 is a schematic diagram of outputting a target image for a prompt image and prompt text according to some embodiments.

### DESCRIPTION OF EMBODIMENTS

In the following descriptions, related "some embodiments" describe a subset of all possible embodiments. However, it may be understood that the "some embodiments" may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in embodiments of this application are clearly and completely described below with reference to the accompanying drawings in some embodiments. Apparently, the described embodiments are merely some rather than all of some embodiments. All other embodiments obtained by a person of skill in the art based on some embodiments without creative efforts fall within the scope of protection of this application.

To make the objectives, technical solutions, and advantages of this application clearer, this application is described in further detail below with reference to the accompanying drawings. The described embodiments are not to be considered as a limitation on this application. All other embodiments obtained by a person of skill in the art without creative efforts fall within the scope of protection of this application.

In the following description, the involved term "some embodiments" describes a subset of all possible embodiments. However, "some embodiments" may be the same subset or different subsets of all possible embodiments, and may be combined with each other if no conflict arises. In the following description, the involved term "a plurality of" means at least two.

In the following description, the involved term "first/second/third" is merely used to distinguish between similar objects and does not denote order of objects. Specific order or sequence of the term "first/second/third" can be interchanged where permitted, whereby some embodiments described herein can be implemented in order other than that illustrated or described herein.

Unless otherwise defined, all technical and scientific terms used herein have the same meaning as commonly understood by a person of skill in the technical field to which this application belongs. Terms used herein are merely intended to describe some embodiments, but are not intended to limit this application.

In the embodiment of this application, the term "module" or "unit" refers to a computer program with a preset function or a part of the computer program, operates, together with another related part, to implement a preset target, and may be completely or partially implemented by using software, hardware (such as a processing circuit or a memory), or a combination thereof. Similarly, a single processor (or a plurality of processors or memories) may be configured to implement one or more modules or units. In addition, each module or unit may be a part of an integral module or unit including a function of the module or unit.

Before some embodiments are described in further detail, nouns and terms involved in some embodiments are described. The nouns and terms involved in some embodiments are applicable to the following explanations.

(1) Artificial intelligence (AI): it refers to a theory, method, technology, and application system that uses digital computers or digital computer-controlled machines to simulate, extend, and expand human intelligence, perceive the environment, acquire knowledge, and use knowledge to obtain optimal results. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. Basic AI technologies generally include, for example, a sensor, a dedicated AI chip, cloud computing, distributed storage, a big data processing technology, a pre-trained model (PTM) technology, an operating/interaction system, and electromechanical integration. The PTM is also referred to as a large model or a model, and may be widely applied to downstream tasks in various large directions of AI after fine tuning. AI software technologies mainly include several major directions such as computer vision (CV) technology, speech processing technology, natural language processing (NLP) technology, and machine learning (ML)/deep learning.

In some embodiments, an involved text-to-image generation model is a model constructed based on the AI principle.

(2) CV technology: the CV technology is a science that studies how to make a machine "see". Further, it refers to machine vision that uses a camera and a computer to replace human eyes to perform recognition, tracking, and measurement on a target, and further perform image processing, to transform images into a form more suitable for human observation or for transmission to instruments for detection. As a scientific discipline, CV studies related theories and technologies and attempts to establish an AI system that can obtain information from images or multidimensional data. Large model technologies bring an important change to development of CV technologies. PTMs in the field of vision, such as swin-transformers, ViT, V-MOE, and MAE, can be quickly and widely applied to downstream tasks after fine tuning. Typically, the CV technology include techniques such as image processing, image recognition, image semantic understanding, image retrieval, optical character recognition (OCR), video processing, video semantic understanding, video content/behavior recognition, three-dimensional (3D) object reconstruction, 3D technology, virtual reality, augmented reality, and simultaneous localization and mapping, and further includes biometric recognition technologies such as face recognition and fingerprint recognition.

(3) NLP: it is an important direction in the fields of computer science and AI. It studies various theories and methods that enable effective communication between humans and computers using natural languages. NLP involves natural languages, namely languages daily used by people, and is closely related to linguistic research. NLP also involves both computer science and mathematics. Similarly, the large model technology may be applied to the field of NLP. For example, a PTM in the field of NLP, such as a large language model (LLM), can be quickly and widely applied to downstream tasks after fine tuning. The NLP technology usually includes technologies, such as text processing, semantic understanding, machine translation, robot question answering, and knowledge mapping.

In some embodiments, the CV technology and the NLP technology are employed to research how to convert a text description into an appropriate image.

(4) ML: it is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, to keep improving its performance. ML is the core of AI, is a way to make the computer intelligent, and is applied to various fields of AI. ML and deep learning include technologies such as an artificial neural network (ANN), a belief network, reinforcement learning, transfer learning, inductive learning, and learning from demonstrations. A PTM is a latest development result of deep learning, and combines the foregoing technologies.

In some embodiments, a text-to-image generation model may be trained based on a machine learning principle.

(5) Text-to-image generation model: it is configured to convert text descriptions into images. The text-to-image generation model guides generation of an image based on a condition feature in condition feature space. In a text-to-image generation model, the condition feature space is text feature space.

A type of the text-to-image generation model is not limited in some embodiments, and the text-to-image generation model may be, for example, a Stable Diffusion (SD) model or an SDXL model.

(6) Multi-modal model: it is a model that can accept a variety of input forms (such as text, an image, a speech, and a video). The multi-modal model can process and analyze a plurality of types of data, to understand and use various information more comprehensively.

In some embodiments, the multi-modal model includes at least an image feature extraction network configured for implementing image feature extraction and a text feature extraction network configured for implementing text feature extraction. The image feature extraction network is also referred to as an image encoder, and the text feature extraction network is also referred to as a text encoder. A type of the multi-modal model is not limited in some embodiments, and the multi-modal model may be, for example, a Contrast Language-Image Pre-training (CLIP) model, a Large Language And Vision Assistant (LLAVA) model, or a Bootstrapping Language-Image Pre-training (BLIP) model.

(7) PTM: it is also referred to as a foundation model or a large model, refers to a deep neural network (DNN) with a large quantity of parameters, and is trained based on massive amount of unlabeled data. A function approximation capability of the DNN with a large quantity of parameters to enables the PTM to extract a common feature from data, and the DNN is applied to downstream tasks through technologies such as fine tuning, parameter efficient fine tuning (PEFT), and prompt-tuning. Therefore, the PTM may achieve an ideal effect in a few-shot or zero-shot scenario. Base on modality of processed data, PTMs may be classified into language models (ELMO, BERT, and GPT), visual models (swin-transform, ViT, and V-MOE), speech models (VALL-E), multi-modal models (ViBERT, CLIP, Flamingo, and Gato), and the like. The PTM is an important tool of the AIGC, and may also be used as a general interface for connecting a plurality of task models.

The text-to-image generation model and the multi-modal model that are used in some embodiments may both be PTMs. In this way, training efficiency can be improved, for example, a good effect can be achieved after a small amount of training.

(8) Feature space: It is an important concept in ML. Feature of samples may be represented as vectors, and space formed by these vectors is referred to as feature space. By mapping samples into the feature space, various ML algorithms, including classification, clustering, regression, and the like, can be executed.

(9) Binding ID: it refers to training a text-to-image generation model based on sample images with an ID, to bind the trained text-to-image generation model to the ID, for example, the trained text-to-image generation model can generate an image conforming to the ID in a model inference phase. The ID refers to a characteristic of an image, such as a style, an included object (such as a person), and quality. For example, the text-to-image generation model may be trained based on a plurality of sample images having a style, to enable the trained text-to-image generation model to generate an image having the same style in a model inference phase. The text-to-image generation model may be trained based on a plurality of sample images including a object, to enable the trained text-to-image generation model to generate an image including the same object in a model inference phase.

In a solution provided in the related art, a large quantity of image-text pairs are usually used to train a text-to-image generation model. However, the solution has at least the following problems:

A training effect of the text-to-image generation model highly depends on quality of the image-text pairs. In practice, to obtain a text-to-image generation model with a good effect, a significant amount of time and manpower may be required for generating high-quality text annotations (the text annotation refers to text in the image-text pair). However, quality of text annotations automatically generated by a multi-modal model (such as BLIP) is often low, and it is difficult to avoid incorrect annotations caused by "hallucinations" of the model.

It is difficult for text to completely summarize abundant semantic information in an image, and a plurality of sample images with high homogenization (the plurality of sample images all correspond to an ID) are often used in a model training phase. Therefore, a model parameter inevitably converges to narrow space in the model training phase. This adversely impacts the semantic understanding and generative capabilities of the text-to-image generation model.

Some embodiments provide an AI-based text-to-image generation model training method, and image generation method and apparatus, an electronic device, a computer-readable storage medium, and a computer program product. Training of a text-to-image generation model can be driven by an image solely, which breaks dependency on image-text pairs. In addition, rich semantic information included in images is directly used to guide model training, to maximally preserve capabilities of an original model. The following describes exemplary application of the electronic device provided in some embodiments. The electronic device provided in some embodiments may be implemented as various types of terminal devices, or may be implemented as a server.

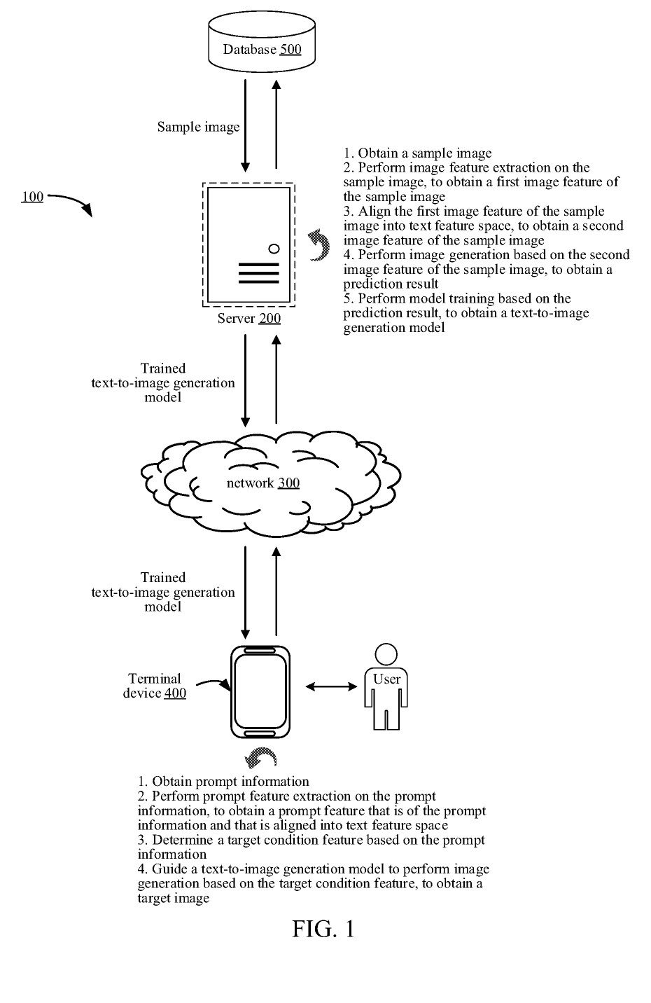

FIG. 1 is a schematic architectural diagram of an AI-based image generation system 100 according to some embodiments. A terminal device 400 is connected to a server 200 through a network 300, and the server 200 is connected to a database 500. The network 300 may be a wide area network, a local area network, or a combination thereof.

In some embodiments, an example in which the electronic device is a server is used. The AI-based text-to-image generation model training method and image generation method provided in some embodiments may both be implemented by the server. For example, the server 200 may obtain a sample image from the database 500, and perform image feature extraction on the sample image, to obtain a first image feature of the sample image. The server 200 aligns the first image feature of the sample image into text feature space, to obtain a second image feature of the sample image, performs image generation based on the second image feature of the first sample image, to obtain a prediction result, and performs model training based on the prediction result, to obtain a text-to-image generation model. A storage location of the first sample image is not limited, and is not limited to the database 500. For example, the first sample image may be stored in a location such as a distributed file system of the server 200 or a blockchain.

After completing training of the text-to-image generation model, the server 200 may obtain prompt information transmitted by the terminal device 400, perform prompt feature extraction on the prompt information, to obtain a prompt feature that is of the prompt information and that is aligned into the text feature space, generate a target condition feature based on the prompt feature of the prompt information, guide the trained text-to-image generation model to perform image generation based on the target condition feature, to obtain a target image, and transmit the target image to the terminal device 400 in response to the prompt information.

In some embodiments, an example in which the electronic device is a terminal device is used. The AI-based text-to-image generation model training method and image generation method provided in some embodiments may both be implemented by the terminal device. For example, the terminal device 400 may obtain a first sample image locally or from another storage location, and enter a model training phase based on the first sample image, to obtain a trained text-to-image generation model. Then, the terminal device 400 may receive prompt information inputted by a user, and enter a model inference phase based on the prompt information, to obtain a target image outputted by the trained text-to-image generation model. The terminal device 400 may display the target image in response to the prompt information inputted by the user.

In some embodiments, the AI-based text-to-image generation model training method provided in some embodiments may be implemented by a server, and the AI-based image generation method provided in some embodiments may be implemented by a terminal device. For example, the server 200 may obtain a first sample image from the database 500, and enter a model training phase based on the first sample image, to obtain a trained text-to-image generation model. Then, the server 200 transmits the trained text-to-image generation model (which may be a model parameter of the trained text-to-image generation model) to the terminal device 400, and the terminal device 400 deploys the trained text-to-image generation model locally. In this way, training efficiency may be improved through a computing capability of the server 200. After deploying the trained text-to-image generation model locally, the terminal device 400 can provide a model inference capability locally.

In some embodiments, the terminal device 400 or the server 200 may implement the AI-based text-to-image generation model training method and the AI-based image generation method that are provided in some embodiments by running a computer program. For example, the computer program may be a native program or software module in an operating system; or may be a native application (APP), for example, a program that may be deployed in the operating system to run; or may be a mini program, for example, a program that only may be downloaded into a browser environment to run; or may be a mini program that can be embedded into any APP and that can be run or closed by a user. In summary, the foregoing computer program may be an application program, a module, or a plug-in in any form.

In some embodiments, the server 200 may be an independent physical server, or may be a server cluster or distributed system including a plurality of physical servers, or may be a cloud server providing cloud computing services, such as a cloud service, a cloud database, cloud computing, a cloud function, cloud storage, a network service, cloud communication, a middleware service, a domain name service, a security service, a content delivery network (CDN), and a big data and AI platform. The terminal device 400 may be, but is not limited to, a smartphone, a tablet computer, a notebook computer, a desktop computer, an intelligent voice interaction device, a smart home appliance, an in-vehicle terminal, an aircraft, or the like. The terminal device may be connected directly or indirectly to the server by using a wired or wireless communication protocol. This is not limited in this application.

Some embodiments may be applied to various scenarios, including but not limited to, cloud technology, AI, smart transportation, assisted driving, and the like. For example, some embodiments may be applied to design of game concept art. A designer only may input prompt information, and a target image may be automatically generated by using a trained text-to-image generation model. In this way, automatic design of game concept art may be implemented. Alternatively, it is convenient for the designer to perform modification on the generated target image to obtain game concept art, whereby workload can be effectively reduced and design efficiency is improved.

In some embodiments, various data (such as various samples and model parameters) involved in some embodiments may be stored in a blockchain. Credibility of the data is ensured based on immutability of the blockchain.

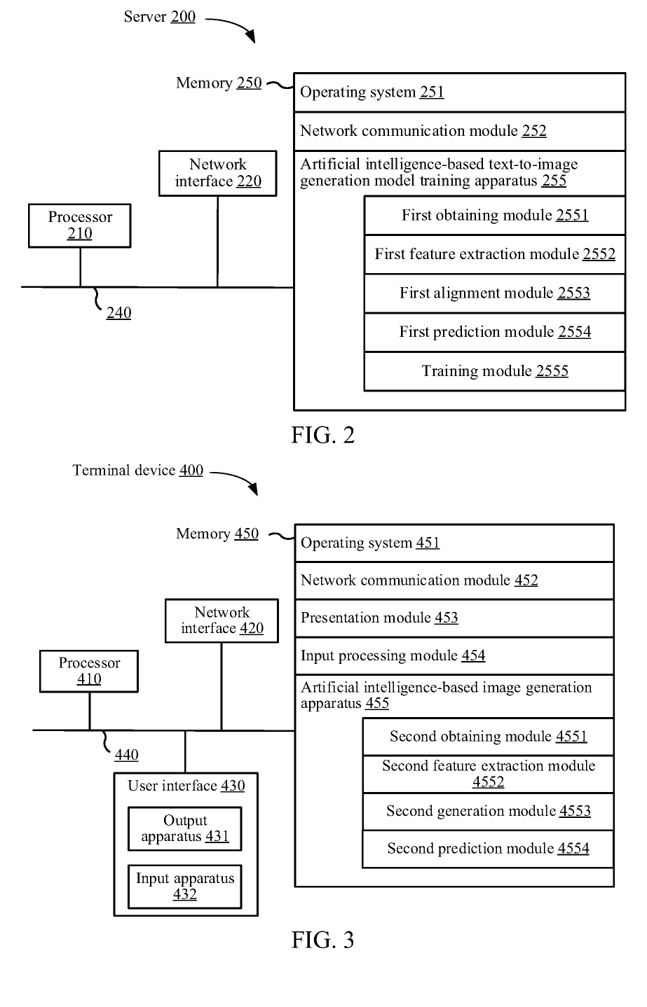

A description is made by using an example in which the electronic device provided in some embodiments is a server. FIG. 2 is a schematic structural diagram of a server 200 according to some embodiments. The server 200 shown in FIG. 2 includes: at least one processor 210, a memory 250, and at least one network interface 220. The components in the server 200 are coupled together through a bus system 240. The bus system 240 is configured to implement connection and communication between the components. In addition to a data bus, the bus system 240 further includes a power bus, a control bus, and a state signal bus. However, for clear description, all types of buses in FIG. 2 are marked as the bus system 240.

The processor 210 may be an integrated circuit chip with a signal processing capability, such as a general-purpose processor, a digital signal processor (DSP), or another programmable logic device, discrete gate or transistor logic device, or discrete hardware component. The general-purpose processor may be a microprocessor, any processor, or the like.

The memory 250 may be a removable memory, a non-removable memory, or a combination thereof. Exemplary hardware devices include a solid memory, a hard disk drive, an optical disk drive, and the like. In some embodiments, the memory 250 includes one or more storage devices physically remote from the processor 210.

The memory 250 includes a volatile memory or a non-volatile memory, or may include both a volatile memory and a non-volatile memory. The non-volatile memory may be a read-only memory (ROM), and the volatile memory may be a random-access memory (RAM). The memory 250 described in some embodiments is intended to include any suitable type of memory.

In some embodiments, the memory 250 is capable of storing data to support various operations. Examples of the data include a program, a module, and a data structure or a subset or superset thereof, which are described exemplarily below.

An operating system 251 includes a system program configured for processing various system services and performing a hardware-related task, such as a framework layer, a core library layer, and a driver layer, and is configured for implementing various services and processing a hardware-based task.

A network communication module 252 is connected to another computing device through one or more (wired or wireless) network interfaces 220. Exemplary network interfaces 220 include: Bluetooth, Wireless Fidelity (Wi-Fi), a universal serial bus (USB), and the like.

In some embodiments, the AI-based text-to-image generation model training apparatus provided in some embodiments may be implemented by using software. FIG. 2 shows an AI-based text-to-image generation model training apparatus 255 stored in the memory 250. The apparatus may be software in the form of a program, a plug-in, or the like, and includes the following software modules: a first obtaining module 2551, a first feature extraction module 2552, a first alignment module 2553, a first prediction module 2554, and a training module 2555. These modules are logical modules, and may be combined in any manner or further divided based on implemented functions. Functions of the modules are described below.

A description is made by using an example in which the electronic device provided in some embodiments is a terminal device. In a case that the electronic device is a server, parts (such as a user interface, a presentation module, and an input processing module) in a structure shown in FIG. 3 may be omitted. FIG. 3 is a schematic structural diagram of a terminal device 400 according to some embodiments. The terminal device 400 shown in FIG. 3 includes: at least one processor 410, a memory 450, at least one network interface 420, and a user interface 430. The components in the terminal device 400 are coupled together through a bus system 440. The bus system 440 is configured to implement connection and communication between the components. In addition to a data bus, the bus system 440 further includes a power bus, a control bus, and a state signal bus. However, for clear description, all types of buses in FIG. 3 are marked as the bus system 440.

The processor 410 may be an integrated circuit chip with a signal processing capability, such as a general-purpose processor, a DSP, or another programmable logic device, discrete gate or transistor logic device, or discrete hardware component. The general-purpose processor may be a microprocessor, any processor, or the like.

The user interface 430 includes one or more output apparatuses 431 capable of presenting media content, including one or more speakers and/or one or more visual display screens. The user interface 430 further includes one or more input apparatuses 432, including user interface components that facilitate user input, such as a keyboard, a mouse, a microphone, a touchscreen, a camera, and other input button or control.

The memory 450 may be a removable memory, a non-removable memory, or a combination thereof. Exemplary hardware devices include a solid memory, a hard disk drive, an optical disk drive, and the like. In some embodiments, the memory 450 includes one or more storage devices physically remote from the processor 410.

The memory 450 includes a volatile memory or a non-volatile memory, or may include both a volatile memory and a non-volatile memory. The non-volatile memory may be a ROM, and the volatile memory may be a RAM. The memory 450 described in some embodiments is intended to include any suitable type of memory.

In some embodiments, the memory 450 is capable of storing data to support various operations. Examples of the data include a program, a module, and a data structure or a subset or superset thereof, which are described exemplarily below.

An operating system 451 includes a system program configured for processing various system services and performing a hardware-related task, such as a framework layer, a core library layer, and a driver layer, and is configured for implementing various services and processing a hardware-based task.

A network communication module 452 is connected to another computing device through one or more (wired or wireless) network interfaces 420. Exemplary network interfaces 420 include: Bluetooth, Wi-Fi, an USB, and the like.

A presentation module 453 is configured to present information through the one or more output apparatuses 431 (such as a display screen or speaker) associated with the user interface 430 (such as a user interface configured for operating a peripheral device and displaying content and information).

An input processing module 454 is configured to detect one or more user inputs or interactions from one of the one or more input apparatuses 432 and translate the detected inputs or interactions.

In some embodiments, the AI-based text-to-image generation model training apparatus provided in some embodiments may be implemented by using software. FIG. 3 shows an AI-based text-to-image generation model training apparatus 455 stored in the memory 450. The apparatus may be software in the form of a program, a plug-in, or the like, and includes the following software modules: a second obtaining module 4551, a second feature extraction module 4552, a second generation module 4553, a second prediction module 4554. The modules are logical modules, and may be combined in any manner or further divided based on implemented functions. Functions of the modules are described below.

The AI-based text-to-image generation model training method provided in some embodiments is described with reference to the exemplary application and implementation of the electronic device provided in some embodiments.

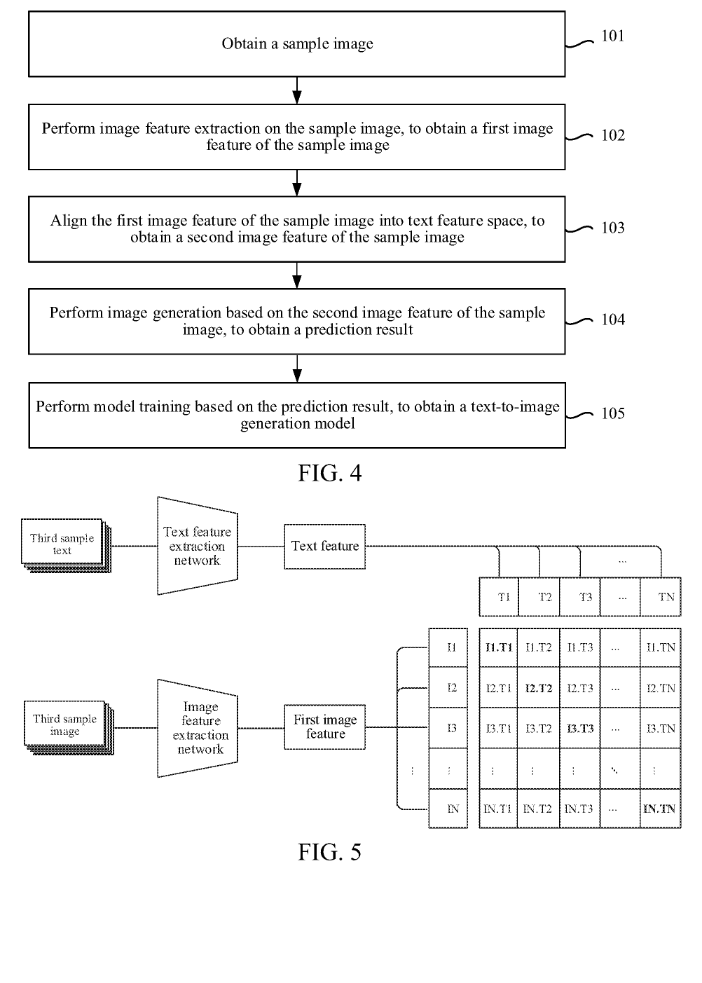

FIG. 4 is a schematic flowchart of an AI-based text-to-image generation model training method according to some embodiments. A description is made with reference to operations shown in FIG. 4.

Operation 101: Obtain a sample image.

Herein, a training data set of a text-to-image generation model is obtained. The training data set of the text-to-image generation model includes a plurality of first sample images.

In some embodiments, to improve a training effect of the text-to-image generation model, a plurality of sample images are provided.

In some embodiments, the plurality of sample images in the training data set of the text-to-image generation model all have a same ID, whereby a trained text-to-image generation model is bound to the ID. The ID refers to a characteristic of an image, such as a style, an included object (such as a person), and quality. For example, the training data set of the text-to-image generation model includes a plurality of sample images having a same style. In this way, the trained text-to-image generation model generates a target image having the same style in a model inference phase. The training data set of the text-to-image generation model includes a plurality of sample images including a same object. In this way, the trained text-to-image generation model generates a target image including the same object in the model inference phase.

Operation 102: Perform image feature extraction on the sample image, to obtain a first image feature of the sample image.

Herein, image feature extraction is performed on the sample image, to extract semantic information in the sample image, and obtain the first image feature of the sample image.

In some embodiments, image feature extraction may be performed on the sample image by using an image feature extraction network, to obtain the first image feature of the sample image. The image feature extraction network may be pre-trained, for example, may be an image feature extraction network in a multi-modal model.

Operation 103: Align the first image feature of the sample image into text feature space, to obtain a second image feature of the sample image.

The text-to-image generation model is configured to generate an image based on text. That is, the text-to-image generation model guides generation of an image based on a text feature in the text feature space. Therefore, in some embodiments, the first image feature of the sample image is aligned (linearly aligned) into the text feature space, to obtain the second image feature of the sample image. In this way, the second image feature of the sample image may be considered as a text feature in the text feature space, to guide generation of an image.

That the feature is aligned into the text feature space means that the feature is converted (or mapped), to make a dimension of the converted feature conform to a form of a dimension in the text feature space. The form of the dimension in the text feature space is related to a type of the text-to-image generation model, and may be preset. For example, the form of the dimension in the text feature space may be set to n*768, where 1*768 indicates one Token. Based on the form of the dimension in the text feature space, a dimension of the second image feature may also be preset, for example, set to 3*768.

For example, if the form of the dimension in the text feature space is n*768, and a dimension of the first image feature is 1*1024, the first image feature whose dimension is 1*1024 may be converted into a second image feature whose dimension is 3*768. In this case, the second image feature whose dimension is 3*768 is located in the text feature space.

In some embodiments, conversion from the first image feature to the second image feature may be implemented by using an alignment network. The alignment network may be preset, or may be obtained through training.

The alignment network, the image feature extraction network, and a text feature extraction network involved in some embodiments all refer to ANNs.

Operation 104: Perform image generation based on the second image feature of the sample image, to obtain a prediction result.

In this embodiment, a sample condition feature is determined based on the second image feature of the sample image, and image generation is performed based on the sample condition feature, to obtain the prediction result.

The sample condition feature is used as a guiding condition for generating an image by using a to-be-trained text-to-image generation model.

Because the second image feature of the sample image is already located in the text feature space, the sample condition feature may be generated based on the second image feature of the sample image. For example, the second image feature of the sample image may be directly determined as the sample condition feature, or the second image feature of the sample image may be further processed to obtain the sample condition feature. Therefore, by directly determining the second image feature of the sample image as the sample condition feature, the training process becomes lightweight, to reduce an amount of data processing in the training process and improve processing efficiency. By further processing the second image feature of the sample image to obtain the sample condition feature, the sample condition feature with rich detailed features are obtained after processing, to enable the text-to-image generation model to achieve a good image generation effect.

Operation 105: Perform model training based on the prediction result, to obtain a text-to-image generation model.

In this embodiment, a loss value is determined based on the prediction result, and model training is performed based on the loss value, to obtain the text-to-image generation model.

Herein, the to-be-trained text-to-image generation model is guided to perform image generation based on the sample condition feature. That is, the to-be-trained text-to-image generation model performs image generation with reference to the sample condition feature. The loss value is calculated based on the prediction result generated in the image generation process, and the text-to-image generation model is trained based on the loss value until training of the text-to-image generation model is completed. The loss value may be a mean square error (MSE) loss value, or may be another type of loss value. A loss generated by the text-to-image generation model in the training process may be determined based on the prediction result, and the model is adjusted based on the generated loss for re-training. In this way, a feature extraction capability, a feature alignment capability, and an image generation capability of the model are gradually enhanced in the training process, to gradually reduce the generated loss.

The model training phase of the text-to-image generation model can be driven by the sample image solely without spending time and manpower on text annotation, which breaks dependency on image-text pairs, and can establish an automatic training procedure without human intervention. In addition, the second image feature obtained by aligning the first image feature of the sample image into the text feature space includes abundant semantic information in the sample image, which can effectively enhance a semantic understanding capability and an image generation capability of the trained text-to-image generation model.

A condition for completing training of the text-to-image generation model is not limited in some embodiments. For example, the condition may be that a preset quantity of times of training is reached, or a performance indicator reaches an indicator threshold.

In some embodiments, the sample image includes at least one of a first sample image, a second sample image, and a third sample image. The first sample image is configured for training the text-to-image generation model, the second sample image is configured for training an alignment network, the alignment network is configured for aligning a first image feature of the first sample image into the text feature space, the third sample image is configured for training a multi-modal model, and the multi-modal model is configured to extract the first image feature of the first sample image.

The sample condition feature includes at least one of a first sample condition feature, a second sample condition feature, and a third sample condition feature, the prediction result includes at least one of a first prediction result, a second prediction result, and a third prediction result, and the loss value includes at least one of a first loss value, a second loss value, and a third loss value.

At least one of the first sample image, the second sample image, or the third sample image may be configured for training the text-to-image generation model. The second sample image may be configured for training the alignment network, and the third sample image may be configured for training the multi-modal model. The third sample image is further configured for training and updating an embedded image feature.

In this embodiment, when the sample image includes the first sample image, the sample condition feature includes the first sample condition feature, the prediction result includes the first prediction result, and the loss value includes the first loss value. Image feature extraction is performed on the first sample image, to obtain a first image feature of the first sample image, and the first image feature of the first sample image is aligned into the text feature space, to obtain a second image feature of the first sample image. The first sample condition feature is determined based on the second image feature of the first sample image, and image generation is performed based on the first sample condition feature, to obtain the first prediction result. The first loss value is determined based on the first prediction result, and model training is performed based on the first loss value, to obtain the text-to-image generation model.

When the sample image includes the second sample image, the sample condition feature includes the second sample condition feature, the prediction result includes the second prediction result, and the loss value includes the second loss value. Image feature extraction is performed on the second sample image, to obtain a first image feature of the second sample image, and the first image feature of the second sample image is aligned into the text feature space, to obtain a second image feature of the second sample image. The second sample condition feature is determined based on the second image feature of the second sample image, and image generation is performed based on the second sample condition feature, to obtain the second prediction result. The second loss value is determined based on the second prediction result, and model training is performed based on the second loss value, to obtain the text-to-image generation model.

Further, when the sample image includes the second sample image, second sample text corresponding to the second sample image is obtained, and a text feature of the second sample text is extracted. Feature fusion is performed on the second image feature of the second sample image and the text feature of the second sample text, to obtain the second sample condition feature. The second sample condition feature is generated based on the second image feature of the second sample image, and image generation is performed based on the second sample condition feature, to obtain the second prediction result.

When the sample image includes the third sample image, the sample condition feature includes the third sample condition feature, the prediction result includes the third prediction result, and the loss value includes the third loss value. Image feature extraction is performed on the third sample image, to obtain a first image feature of the third sample image, and the first image feature of the third sample image is aligned into the text feature space, to obtain a second image feature of the third sample image. The third sample condition feature is determined based on the second image feature of the third sample image, and image generation is perform based on the third sample condition feature, to obtain the third prediction result. The third loss value is determined based on the third prediction result, and model training is performed based on the third loss value, to obtain the text-to-image generation model.

In this embodiment, model training may be performed with reference to at least one type of sample image, and the alignment network, the multi-modal model, and the text-to-image generation model may all be trained separately or trained jointly.

The multi-modal model is trained separately. For example, a plurality of third sample images and third sample text respectively corresponding to the plurality of third sample images are obtained. A first image feature of each third sample image is extracted by using an image feature extraction network in the multi-modal model. A text feature of each third sample text is extracted by using a text feature extraction network in the multi-modal model. A feature extraction loss value is determined based on the first image feature of each third sample image and the text feature of each third sample text, and the multi-modal model is trained based on the feature extraction loss value, to obtain a trained multi-modal model.

After training of the multi-modal model is completed, the alignment network is trained separately. For example, a second sample image and corresponding second sample text are obtained, and a first image feature of the second sample image is extracted by using the image feature extraction network in the trained multi-modal model. A text feature of the second sample text is extracted by using the text feature extraction network in the trained multi-modal model. The first image feature of the second sample image is aligned into the text feature space by using the to-be-trained alignment network, to obtain a second image feature of the second sample image. Feature fusion is performed on the second image feature of the second sample image and the text feature of the second sample text, to obtain a second sample condition feature, and image generation is performed based on the second sample condition feature, to obtain a second prediction result. A second loss value is determined based on the second prediction result, and the alignment network is trained based on the second loss value, to obtain a trained alignment network.

After training of the multi-modal model and training of the alignment network are completed, the text-to-image generation model is trained separately. For example, a first sample image is obtained, and a first image feature of the first sample image is extracted by using the image feature extraction network in the trained multi-modal model. The first image feature of the first sample image is aligned into the text feature space by using the trained alignment network, to obtain a second image feature of the first sample image. A first sample condition feature is generated based on the second image feature of the first sample image, and image generation is performed based on the first sample condition feature, to obtain a prediction result. A first loss value is determined based on the prediction result, and the text-to-image generation model is trained based on the first loss value.

In this embodiment, the alignment network, the multi-modal model, and the text-to-image generation model are all trained separately. This can reduce training complexity, reduce training difficulty, and help improve training efficiency. The multi-modal model is configured to extract an image feature and a text feature. The alignment network is configured for aligning the image feature into text feature space, to obtain a sample condition feature. The text-to-image generation model is configured to generate an image based on the sample condition feature. Joint training can better learn a potential association among image feature extraction, text feature extraction, feature alignment, and image generation, to improve accuracy of image feature extraction, accuracy of text feature extraction, accuracy of image feature alignment into the text feature space, and accuracy of image generation.

In the foregoing operations, the model training phase of the text-to-image generation model is described by using a single sample image as an example. However, a plurality of sample images may participate in the model training phase of the text-to-image generation model.

The training the text-to-image generation model based on the loss value may refer to performing back propagation on the loss value in the text-to-image generation model, and updating a model parameter of the text-to-image generation model in a gradient descending direction during back propagation. The model parameter involved in some embodiments is configured for defining a structure and a feature representing capability of the ANN. The model parameter may include a weight parameter, and may further include a bias parameter. The essence of training the model is updating the model parameter.

In some embodiments, the training the text-to-image generation model based on the loss value may be implemented in such a manner: performing any one of the following processing: learning a first sub-incremental parameter and a second sub-incremental parameter based on the loss value, performing parameter fusion on the first sub-incremental parameter and the second sub-incremental parameter to obtain an incremental parameter, and updating the model parameter of the text-to-image generation model based on the incremental parameter; or learning an incremental parameter based on the loss value, and updating a model parameter of the text-to-image generation model based on the incremental parameter, a dimension of the incremental parameter being the same as a dimension of the model parameter.

Herein, two manners of training the text-to-image generation model based on the loss value are provided:

1) Learning a first sub-incremental parameter and a second sub-incremental parameter based on the loss value, performing parameter fusion on the first sub-incremental parameter and the second sub-incremental parameter to obtain an incremental parameter, and updating the model parameter of the text-to-image generation model based on the incremental parameter, a dimension of the incremental parameter being the same as a dimension of the model parameter, and parameter fusion being multiplication.

For example, if the model parameter of the text-to-image generation model is denoted as W, where W is an m×n matrix, the incremental parameter ΔW that may be learned is also an m×n matrix. Based on this, the to-be-learned incremental parameter ΔW may be decomposed into a first sub-incremental parameter ΔW1 and a second sub-incremental parameter ΔW2 based on a rank number r, where ΔW1 is an m×r matrix, ΔW2 is a r×n matrix, and the rank number r may be set according to an actual application scenario. After the first sub-incremental parameter ΔW1 and the second sub-incremental parameter ΔW2 are learned based on the loss value, parameter fusion is performed on the first sub-incremental parameter ΔW1 and the second sub-incremental parameter ΔW2 to obtain the incremental parameter, for example, ΔW=ΔW1×ΔW2. Then, the model parameter W of the text-to-image generation model is updated based on the incremental parameter ΔW, for example, W=W+ΔW is performed.

Essentially, in this manner, the text-to-image generation model is used as a base model, a low-rank adaptive (LoRA) model is trained based on the loss value, a model parameter of the trained LoRA model includes the first sub-incremental parameter and the second sub-incremental parameter that are learned based on the loss value, and then the trained LoRA model is inserted into the base model to obtain the trained text-to-image generation model, for example, the trained text-to-image generation model = the base model + the trained LoRA model.

In the manner 1), a small quantity of parameters need to be learned, which can improve model training efficiency and reduce computing resource consumption in the model training process. In addition, the LoRA model stores the model parameter in a matrix multiplication manner. Therefore, a small amount of storage space is occupied, deployment is convenient, plug-and-play can be implemented, and good transferability is achieved on different base models (network structures of different base models are the same, but model parameters are different).

2) Learning an incremental parameter based on the loss value, and updating a model parameter of the text-to-image generation model based on the incremental parameter. For example, the incremental parameter ΔW may be directly learned, and an operation of W=W+ΔW is performed. In the manner 2), a large quantity of parameters need to be learned, whereby the trained text-to-image generation model achieves a good image generation effect.

In an actual application scenario, the manner 1) or the manner 2) may be selected for training according to a focus of attention. For example, if more attention is paid to training efficiency and training consumption, the manner 1) is selected; or if more attention is paid to accuracy, and training efficiency and training consumption are not considered, the manner 2) is selected.

In this embodiment, the loss value in the manner 1) or the manner 2) may be at least one of the first loss value, the second loss value, and the third loss value.

As shown in FIG. 4, in some embodiments, the sample image is obtained, and image feature extraction is performed on the sample image, to obtain the first image feature of the sample image. In this way, the second image feature of the sample image may be considered as the text feature, and image generation is performed based on the second image feature of the sample image, to obtain the prediction result. Model training is performed based on the prediction result, to obtain the text-to-image generation model. The model training phase of the text-to-image generation model in some embodiments can be driven by the first sample image solely without spending time and manpower on text annotation, which breaks dependency on image-text pairs, and can establish an automatic training procedure without human intervention. In addition, the second image feature of the sample image includes abundant semantic information in the first sample image, which can effectively improve a semantic understanding capability and an image generation capability of the trained text-to-image generation model.

In some embodiments, the aligning the first image feature of the sample image into text feature space, to obtain a second image feature of the sample image includes:

obtaining second sample text corresponding to the second sample image, and extracting a text feature of the second sample text; aligning the first image feature of the first sample image into the text feature space by using the alignment network, to obtain a second image feature of the first sample image; and aligning a first image feature of the second sample image into the text feature space by using the alignment network, to obtain a second image feature of the second sample image.

The determining a sample condition feature based on the second image feature of the sample image includes: determining the first sample condition feature based on the second image feature of the first sample image, and performing feature fusion on the second image feature of the second sample image and the text feature of the second sample text, to obtain the second sample condition feature.

The performing model training based on the loss value, to obtain the text-to-image generation model includes: training a to-be-trained text-to-image generation model based on the first loss value, and training the alignment network based on the second loss value, the trained alignment network being configured for aligning the first image feature of the first sample image into the text feature space, to obtain the second image feature of the first sample image.

Herein, the first image feature of the first sample image may be aligned into the text feature space by using the alignment network, to obtain the second image feature of the first sample image.

To enable the alignment network to better align the first image feature into the text feature space, the alignment network may be trained in advance. A training data set of the alignment network includes several image-text pairs, which facilitates learning a potential association between an image feature and a text feature. For ease of distinguishing, an image in the image-text pair is named a second sample image, and text in the image-text pair is named a second sample text. The second sample image and the second sample text correspond to each other, for example, the second sample text is configured for describing the second sample image.

A manner of obtaining the training data set of the alignment network is not limited in some embodiments. For example, an open-source image-text pair data set may be obtained as the training data set of the alignment network.

A network structure of the alignment network is not limited in the embodiment of this application. For example, the alignment network may include one Linear layer and one Layer Normalization (LN) layer.

Similarly, herein, image feature extraction is performed on the second sample image, to obtain a first image feature of the second sample image. Text feature extraction is performed on the second sample text, to obtain a text feature of the second sample text.

In some embodiments, image feature extraction is performed on the second sample image by using an image feature extraction network, to obtain the first image feature of the second sample image. Text feature extraction is performed on the second sample text by using a text feature extraction network, to obtain the text feature of the second sample text. The image feature extraction network and the text feature extraction network may be trained separately, or may be trained jointly. Joint training can improve effects of image feature extraction and text feature extraction, to better learn the potential association between the image feature and the text feature.

In some embodiments, the method further includes: obtaining third sample text respectively corresponding to a plurality of third sample images; extracting a first image feature of each third sample image by using an image feature extraction network in the multi-modal model; extracting a text feature of each third sample text by using a text feature extraction network in the multi-modal model; determining a feature extraction loss value based on the first image feature of each third sample image and the text feature of each third sample text, and training the multi-modal model based on the feature extraction loss value, the image feature extraction network in the trained multi-modal model being configured for performing image feature extraction on the second sample image and the first sample image; and the text feature extraction network in the trained multi-modal model being configured for performing text feature extraction on the second sample text.

Herein, a training data set of the multi-modal model may be obtained, and the image feature extraction network and the text feature extraction network in the multi-modal model are trained jointly based on the training data set of the multi-modal model. The training data set of the multi-modal model includes several image-text pairs. For ease of distinguishing, an image in the image-text pair is named a third sample image, and text in the image-text pair is named a third sample text. The training data set of the multi-modal model and the training data set of the alignment network may be the same or different. This is not limited herein.

In a model training phase of the multi-modal model, the first image feature of each third sample image is extracted by using the image feature extraction network in the multi-modal model, and the text feature of each third sample text is extracted. The feature extraction loss value is determined based on the first image feature of each third sample image and the text feature of each third sample text, and the multi-modal model is trained based on the feature extraction loss value, for example, the image feature extraction network and the text feature extraction network in the multi-modal model are trained (trained jointly).

A loss function may be constructed based on contrastive learning, and the first image feature of each third sample image and the text feature of each third sample text are substituted into the loss function, to obtain the feature extraction loss value. A type of the loss function is not limited. For example, the loss function may be a cross-entropy loss function. For example, the third sample image and corresponding third sample text (for example, the third sample image and the third sample text belong to a same image-sample pair) may form a positive sample, and the third sample image and non-corresponding third sample text may form a negative sample. Based on this, the loss function may be constructed. An objective of the loss function is to maximize a similarity corresponding to the positive sample and minimize a similarity corresponding to the negative sample. The similarity corresponding to the positive sample refers to a similarity between the first image feature of the third sample image in the positive sample and a text feature of the third sample text in the positive sample. The similarity corresponding to the negative sample refers to a similarity between the first image feature of the third sample image in the negative sample and a text feature of the third sample text in the negative sample.

For ease of understanding, embodiments of this application further provide a schematic flowchart of training a multi-modal model shown in FIG. 5. In FIG. 5, N third sample images are included, which are a third sample image 1, a third sample image 2, ..., and a third sample image N, respectively. A first image feature of the third sample image 1 is denoted as I1, and so on. N pieces of third sample text also included, which are third sample text 1, third sample text 2, ..., and third sample text N, respectively. The third sample text 1 corresponds to the third sample image 1. A text feature of the third sample text 1 is denoted as T1. A similarity between the first image feature I1 of the third sample image 1 and the text feature T1 of the third sample text 1 is denoted as I1.T1, and so on. Based on this, an N×N similarity matrix may be obtained. The objective of the loss function is to maximize a similarity on the diagonal of the similarity matrix and minimize a similarity not on the diagonal of the similarity matrix. The diagonal herein refers to a diagonal from I1.T1 at an upper left corner to IN.TN at a lower right corner.

In some embodiments, training of the multi-modal model and training of the text-to-image generation model may be performed simultaneously. Alternatively, after training of the multi-modal model is completed first, parameters of the multi-modal model are fixed, and then the text-to-image generation model is trained.

Training of the multi-modal model and training of the text-to-image generation model may be performed simultaneously. That is, the to-be-trained text-to-image generation model is trained based on the first loss value, and the alignment network is trained based on the second loss value.

In some embodiments, after training of the multi-modal model is completed, the parameters of the multi-modal model are fixed, and then the text-to-image generation model is trained. That is, after training of the multi-modal model is completed, the first image feature of the second sample image is extracted by using the image feature extraction network in the trained multi-modal model, and the text feature of the second sample text is extracted by using the text feature extraction network in the trained multi-modal model. Image feature extraction is performed on the first sample image by using the image feature extraction network in the trained multi-modal model, to obtain the first image feature of the first sample image. By training the multi-modal model in the foregoing manner, effects of image feature extraction and text feature extraction can be enhanced, whereby the alignment network can be trained well, and the first image feature of the first sample image and the first image feature of the second sample image are accurately extracted.

The first image feature of the second sample image is aligned into the text feature space by using the alignment network, to obtain the second image feature of the second sample image. Feature fusion is performed on the second image feature of the second sample image and the text feature of the second sample text, to obtain the second sample condition feature.

Herein, the second image feature of the second sample image has been aligned into the text feature space. Therefore, feature fusion can be performed on the second image feature of the second sample image and the text feature of the second sample text, to obtain the second sample condition feature. A feature fusion manner is not limited, and may be, for example, concatenation. The to-be-trained text-to-image generation model is guided to perform image generation based on the second sample condition feature, to obtain the second prediction result. The second loss value is determined based on the second prediction result, and the alignment network is trained based on the second loss value.

Herein, the to-be-trained text-to-image generation model is guided to perform image generation based on the second sample condition feature, and the second loss value is determined based on the second prediction result generated in the image generation process. Different from operation 105, in the model training phase of the alignment network, all networks except the alignment network are frozen (for example, all model parameters except the model parameter of the alignment network are kept unchanged), for example, the second loss value is configured only for training the alignment network.

The loss function configured for determining the second loss value may be the same as the loss function configured for determining the first loss value.

In some embodiments, the alignment network is trained by using the image-text pairs, and all networks except the alignment network are frozen during training of the alignment network. In this way, the alignment network can learn how to efficiently and accurately align the first image feature into the text feature space in the model training phase of the alignment network. In this way, the first image feature of the first sample image is aligned into the text feature space by using the trained alignment network, to obtain the second image feature of the first sample image, which can enrich semantic information included in the second image feature of the first sample image, and reduce a semantic information loss in the alignment process.

In some embodiments, the first sample condition feature includes at least one of the second image feature of the first sample image and an image fusion feature, and the image fusion feature is obtained by fusing the second image feature of the first sample image with an embedded image feature in the text feature space.

In this embodiment, feature fusion is performed on the second image feature of the first sample image and the embedded image feature in the text feature space, to obtain the first sample condition feature.

Herein, the embedded image feature may be introduced into the text feature space, to bind the first sample image to an ID. Based on this, feature fusion may be performed on the second image feature of the first sample image and the embedded image feature in the text feature space, to obtain the first sample condition feature, whereby the first sample condition feature is comprehensive and accurate.

Based on introduction of the embedded image feature, the embedded image feature is not only employed in the model training phase of the text-to-image generation model, but also employed in a model inference phase of the text-to-image generation model, to enable the text-to-image generation model to output a better target image in the model inference stage.

In some embodiments, the fusing the second image feature of the first sample image with an embedded image feature in the text feature space includes: initializing the embedded image feature in text feature space, and performing feature fusion on the second image feature of the first sample image and the embedded image feature, to obtain the third sample condition feature.

The determining a loss value based on the prediction result, and performing model training based on the loss value, to obtain a text-to-image generation model includes:

determining the third loss value based on the third prediction result; and updating the embedded image feature based on the third loss value, and training the to-be-trained text-to-image generation model based on the first loss value.

In this embodiment, the to-be-trained text-to-image generation model is guided to perform image generation based on the first sample condition feature, to obtain the first prediction result. The to-be-trained text-to-image generation model is guided to perform image generation based on the third sample condition feature, to obtain the third prediction result. The first loss value is determined based on the first prediction result, the third loss value is determined based on the third prediction result, the to-be-trained text-to-image generation model is trained based on the first loss value, and the embedded image feature is updated based on the third loss value.

Herein, the embedded image feature may be trained and updated based on a training data set of the embedded image feature, whereby the embedded image feature achieves a good ID binding effect. The training data set of the embedded image feature may be the same as the training data set of the text-to-image generation model, or may be a subset of the training data set of the text-to-image generation model.

In a training and updating phase of the embedded image feature, the embedded image feature is first initialized (for example, randomly initialized) in the text feature space. A dimension of the embedded image feature conforms to the form of the dimension of the text feature space, and the dimension of the embedded image feature and a dimension of the second image feature may be the same or different. Then, feature fusion is performed on the second image feature of the first sample image and the embedded image feature, to obtain the third sample condition feature, and the to-be-trained text-to-image generation model is guided to perform image generation based on the third sample condition feature, to obtain the third prediction result. The third loss value is determined based on the third prediction result, and the embedded image feature is trained and updated based on the third loss value.

The training and updating phase of the embedded image feature and training of the text-to-image generation model may be performed simultaneously. Alternatively, training and updating of the embedded image feature may be first performed, and then training of the text-to-image generation model is performed after training and updating of the embedded image feature are completed.

For example, in the training and updating phase of the embedded image features, all model parameters except the embedded image features are kept unchanged. After training and updating of the embedded image feature are completed, the second image feature of the first sample image is fused with the embedded image feature in the text feature space, to obtain the first sample condition feature of the first sample image. The to-be-trained text-to-image generation model is guided to perform image generation based on the first sample condition feature, to obtain the first prediction result. The first loss value is determined based on the first prediction result, and the to-be-trained text-to-image generation model is trained based on the first loss value, to obtain the text-to-image generation model.

A loss function configured for determining the third loss value may be the same as the loss function configured for determining the first loss value.

In some embodiments, a plurality of first sample images are provided, and the embedded image feature includes a second image feature of any first sample image.

Herein, in a case that the training data set of the text-to-image generation model includes a plurality of first sample images, a second image feature of any first sample image may be determined as the embedded image feature. In this manner, the embedded image feature can be quickly determined. The ID binding effect of the embedded image feature determined through training (updating) is good.

In this embodiment, feature fusion may be performed on the second image feature of the first sample image and the embedded image feature in the text feature space, to obtain the first sample condition feature. Alternatively, the second image feature of the first sample image may be directly determined as the first sample condition feature. Compared with the first sample condition feature obtained through feature fusion, determining the second image feature as the first sample condition feature is more lightweight. However, the first sample condition feature obtained feature fusion can be bound to the ID based on the embedded image feature. In this way, the text-to-image generation model outputs good target images in the model inference phase, and the target images can be reserved or discarded according to requirements of an actual application scenario.

Some embodiments provides two manners of determining the first sample condition feature based on the second image feature of the first sample image. Either manner may be selected according to requirements of an actual application scenario, which is highly flexible.

In some embodiments, the first prediction result includes predicted noise. The determining a loss value based on the prediction result includes:

mapping the first sample image from pixel space to latent space, to obtain a third image feature of the first sample image; adding noise to the third image feature of the first sample image, to obtain a noised image feature; performing noise extraction on the noised image feature based on the first sample condition feature, to obtain the predicted noise; and using a difference between the added noise and the predicted noise as the first loss value.

In the model training phase of the text-to-image generation model, noise may be first added to an image through a forward process (or referred to as a forward diffusion process), and then the added noise is predicted through a reverse process (or referred to as a reverse reconstruction process). In this way, a powerful image generation capability is obtained through training.

First, the first sample image is mapped from the pixel space to the latent space, to obtain the third image feature of the first sample image. The latent space refers to feature space smaller than the pixel space, and the foregoing forward process and reverse process may be implemented in the latent space, to implement image compression, which makes training efficiency higher.

In some embodiments, a target encoder and a matched target decoder may be trained in advance. The first sample image is mapped from the pixel space to the latent space by using the target encoder, to obtain the third image feature of the first sample image. That is, image feature extraction is performed on the first sample image by using the target encoder, to map the first sample image from the pixel space to the latent space, to obtain the third image feature of the first sample image. For example, the target encoder may refer to an encoder in an auto encoder (AE), and the target decoder may be a decoder in the AE.

In the forward process, adding noise refers to performing noise addition on the third image feature of the first sample image, to obtain the noised image feature. For example, the third image feature may be fused with an image feature of a noised image, to obtain the noised image feature. The noise added during noise addition is known. The noised image may be restored based on the noised image feature.

Noise extraction refers to prediction and extraction of noise of the noised image feature, and extracted noise is the predicted noise. A denoised image feature may be obtained after denoising. A denoised image may be restored based on the denoised image feature.

In the reverse process, denoising is performed on the noised image feature by using the text-to-image generation model based on the first sample condition feature, for example, noise in the noised image feature is predicted and removed, to obtain the denoised image feature.

In some embodiments, the adding noise to the third image feature of the first sample image, to obtain a noised image feature may be implemented in such a manner: performing T rounds of noise addition iterations, and performing the following processing in a process of a t^{th} round of noise addition iteration: adding noise to an image feature inputted in the t^{th} round of noise addition iteration, to obtain an image feature to be inputted in a (t+1)^{th} round of noise addition iteration, the third image feature of the first sample image being used as an image feature inputted in the 1st round of noise addition iteration; and an image feature obtained after a T^{th} round of noise addition iteration being the noised image feature.

The performing denoising on the noised image feature by using the text-to-image generation model based on the first sample condition feature, to obtain a denoised image feature may be implemented in such a manner: performing T rounds of denoising iterations, and performing the following processing in a process of a t^{th} round of denoising iteration: predicting, by using the text-to-image generation model based on the first sample condition feature, noise in the image feature inputted in the t^{th} round of denoising iteration, and removing the predicted noise from the image feature inputted in the t^{th} round of denoising iteration, to obtain an image feature to be inputted in a (t+1)^{th} round of denoising iteration, the noised image feature being used as an image feature inputted in the 1st round of denoising iteration; an image feature obtained after a T^{th} round of denoising iteration being a denoised image feature; and T being an integer greater than 1, and t being an integer greater than 0 and not greater than T.

Herein, the noise addition process may include the T rounds of noise addition iterations, to gradually add noise. For ease of description, the process of the t^{th} round of noise addition iteration is used as an example for description. T is an integer greater than 1 and may be set according to an actual application scenario, for example, set to 30; and t is an integer greater than 0 and not greater than T. In this case, in the t^{th} round of noise addition iteration, noise is added to the image feature inputted in the t^{th} round of noise addition iteration, to obtain the image feature to be inputted in the (t+1)^{th} round of noise addition iteration. The third image feature of the first sample image is used as the image feature inputted in the 1st round of noise addition iteration. The image feature obtained after the T^{th} round of noise addition iteration (for example, an image feature to be inputted in a (T+1)^{th} round of noise addition iteration) is the noised image feature.

Correspondingly, the denoising process may include the t rounds of denoising iterations, to gradually predict and remove noise. For ease of description, the process of the t^{th} round of denoising iteration is used as an example for description. In this case, in the t^{th} round of denoising iteration, noise in the image feature inputted in the t^{th} round of denoising iteration is predicted by using the text-to-image generation model based on the first sample condition feature, and the predicted noise is removed from the image feature inputted in the t^{th} round of denoising iteration, to obtain the image feature to be inputted in the (t+1)^{th} round of denoising iteration. The noised image feature is used as the image feature inputted in the 1st round of denoising iteration. The image feature obtained after the T^{th} round of denoising iteration (for example, an image feature to be inputted in a (T+1)^{th} round of denoising iteration) is the denoised image feature. The forward process and the backward process are implemented by using the foregoing Markov architecture, to enhance stability and interpretability of the text-to-image generation model in the model training phase.

Herein, the noise added during noise addition is considered as an expected result, the predicted noise extracted during noise extraction is considered as a prediction result, and a difference between the expected result and the prediction result is calculated as the first loss value. A type of a loss function configured for calculating the first loss value is not limited in some embodiments.

Because the noise predicted through denoising is obtained in the model training phase of the text-to-image generation model, the denoised image does not need to be restored based on the denoised image feature.

In some embodiments, the text-to-image generation model includes a feature cross network. The performing noise extraction on the noised image feature by using the text-to-image generation model based on the first sample condition feature, to obtain a denoised image feature may be implemented in such a manner: performing feature crossing on the first sample condition feature and the noised image feature by using the feature crossing network, to predict and remove noise in the noised image feature, to obtain the denoised image feature. The training the text-to-image generation model based on the first loss value may be implemented in such a manner: performing the feature cross network based on the first loss value.

Herein, the text-to-image generation model includes the feature cross network. In the reverse process, feature crossing may be performed on the first sample condition feature and the noised image feature by using the feature cross network, to predict and remove the noise in the noised image feature, to obtain the denoised image feature. Based on this, the model training phase of the text-to-image generation model refers to training of the feature cross network. A network structure of the feature cross network is not limited in some embodiments. For example, the feature cross network may include a multi-head attention layer, and may further include another network layer.

If the denoising process includes the T rounds of denoising iterations, in the process of the t^{th} round of denoising iteration, feature crossing is performed, by using the feature cross network, on the first sample condition feature and the image feature inputted in the t^{th} round of denoising iteration, to predict and remove the noise in the image feature inputted in the t^{th} round of denoising iteration, to obtain the image feature to be inputted in a (t+1)^{th} round of denoising iteration.

In some embodiments, noise is added to an image in the forward process, and the added noise is predicted by using the text-to-image generation model in the reverse process, a first loss value is calculated based on the added noise and the predicted noise, and the text-to-image generation model is trained based on the first loss value, whereby the trained text-to-image generation model can accurately predict noise.

The AI-based image generation method provided in some embodiments is described with reference to the exemplary application and implementation of the electronic device provided in some embodiments.

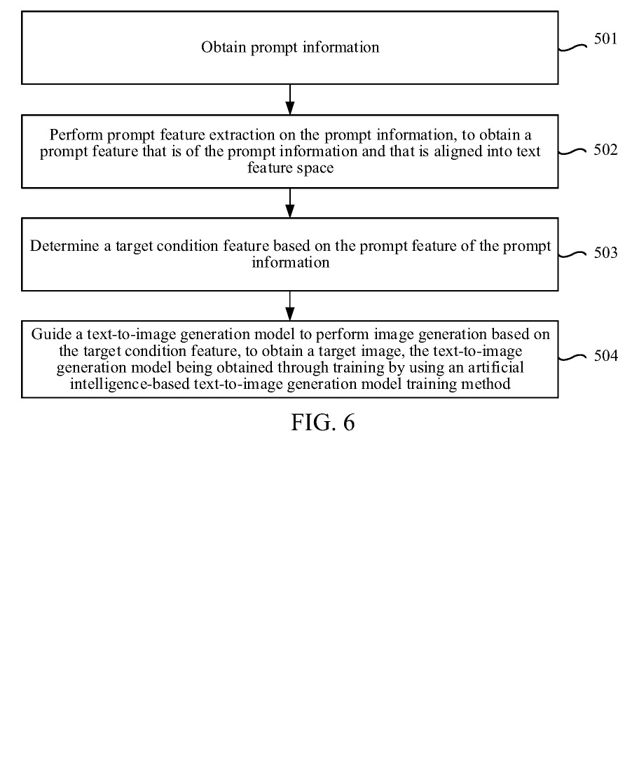

FIG. 6 is a schematic flowchart of an AI-based image generation method according to some embodiments. A description is made with reference to operations shown in FIG. 6.

Operation 501: Obtain prompt information.

After being trained, a text-to-image generation model may enter a model inference phase.

First, the prompt information is obtained. The prompt information is configured for representing requirements for image generation, and the prompt information may include at least one of an image (named a prompt image for distinguishing) and text (named prompt text for distinguishing).

Operation 502: Perform prompt feature extraction on the prompt information, to obtain a prompt feature that is of the prompt information and that is aligned into text feature space.

Herein, prompt feature extraction is performed on the prompt information based on a modality of the prompt information, to obtain the prompt feature of the prompt information. The prompt feature of the prompt information has been aligned into the text feature space.

In some embodiments, the performing prompt feature extraction on the prompt information, to obtain a prompt feature that is of the prompt information and that is aligned into text feature space in such a manner: performing image feature extraction on the prompt image when the prompt information is a prompt image, to obtain a first image feature of the prompt image, aligning the first image feature of the prompt image into the text feature space, to obtain a second image feature of the prompt image, and determining the second image feature of the prompt image as the prompt feature; or performing text feature extraction on the prompt text when the prompt information is prompt text, to obtain a text feature of the prompt text, and determining the text feature of the prompt text as the prompt feature; or performing feature fusion on the second image feature of the prompt image and the text feature of the prompt text when the prompt information includes the prompt image and the prompt text, to obtain the prompt feature.

Herein, when the prompt information includes only the prompt image, image feature extraction is performed on the prompt image, to obtain the first image feature of the prompt image, the first image feature of the prompt image is aligned into the text feature space, to obtain the second image feature of the prompt image, and the second image feature of the prompt image is determined as the prompt feature. Image feature extraction may be performed on the prompt image by using an image feature extraction network in a trained multi-modal model, to obtain the first image feature of the prompt image. The first image feature of the prompt image may be aligned into the text feature space by using a trained alignment network, to obtain the second image feature of the prompt image.

When the prompt information includes only the prompt text, text feature extraction is performed on the prompt text to obtain the text feature of the prompt text, and the text feature of the prompt text is determined as the prompt feature. Text feature extraction may be performed on the prompt text by using a text feature extraction network in the trained multi-modal model, to obtain the text feature of the prompt text.

When the prompt information includes both the prompt image and the prompt text, image feature extraction is performed on the prompt image, to obtain the first image feature of the prompt image, the first image feature of the prompt image is aligned into the text feature space, to obtain the second image feature of the prompt image, and text feature extraction is performed on the prompt text, to obtain the text feature of the prompt text. Then, feature fusion is performed on the second image feature of the prompt image and the text feature of the prompt text, to obtain the prompt feature.

By using the foregoing method, it is ensured that the prompt feature is aligned into the text feature space, and moreover, the prompt feature can reflect information from all modalities within the prompt information.

Operation 503: Determine a target condition feature based on the prompt feature of the prompt information.

Herein, the prompt feature of the prompt information is located in the text feature space. Therefore, the target condition feature may be determined based on the prompt feature of the prompt information.

In some embodiments, the target condition feature includes at least one of the prompt feature of the prompt information and a target fusion feature. The target fusion feature is obtained by fusing the prompt feature of the prompt information with an embedded image feature in the text feature space.

For example, feature fusion is performed on the prompt feature of the prompt information and the embedded image feature in the text feature space, to obtain the target condition feature. Alternatively, the prompt feature of the prompt information is determined as the target condition feature.

If in a model training phase of the text-to-image generation model, feature fusion processing is performed on a second image feature of a first sample image and the embedded image feature in the text feature space, to obtain a first sample condition feature, in a model inference phase of the text-to-image generation model, feature fusion is also performed on the prompt feature of the prompt information and the embedded image feature in the text feature space, to obtain the target condition feature.

If in the model training phase of the text-to-image generation model, a second image feature of the first sample image is determined as the first sample condition feature, in the model inference phase of the text-to-image generation model, the prompt feature of the prompt information is also determined as the target condition feature.

Operation 504: Guide a text-to-image generation model to perform image generation based on the target condition feature, to obtain a target image, the text-to-image generation model being obtained through training by using an AI-based text-to-image generation model training method.

Herein, the trained text-to-image generation model is guided to perform image generation based on the target condition feature, the generated image is referred to as the target image, and the target image may be used as a response to the prompt information.

In some embodiments, the guiding a text-to-image generation model to perform image generation based on the target condition feature, to obtain a target image may be implemented in such a manner: generating an image feature of a random noise image in latent space; performing denoising on the image feature of the random noise image based on the target condition feature by using the text-to-image generation model, to obtain an image feature of the target image; and mapping the image feature of the target image from the latent space to pixel space, to obtain the target image.

The model inference phase of the text-to-image generation model includes only a reverse process. First, the image feature of the random noise image (such as a random Gaussian noise image) is generated in the latent space, denoising is performed on the image feature of the random noise image based on the target condition feature by using the trained text-to-image generation model, to obtain the image feature of the target image, and the image feature of the target image is mapped from the latent space to the pixel space, to obtain the target image. The image feature of the target image may be mapped from the latent space to the pixel space by using a target decoder. The target decoder is, for example, a decoder in an AE.

In some embodiments, the performing denoising on the image feature of the random noise image based on the target condition feature by using the text-to-image generation model, to obtain an image feature of the target image may be implemented in such a manner: performing T rounds of denoising iterations, and performing the following processing in a process of a t^{th} round of denoising iteration: predicting, by using the text-to-image generation model based on the target condition feature, noise in an image feature inputted in the t^{th} round of denoising iteration, and removing the predicted noise from the image feature inputted in the t^{th} round of denoising iteration, to obtain an image feature to be inputted in a (t+1)^{th} round of denoising iteration, the image feature of the random noise image being used as an image feature inputted in the 1st round of denoising iteration; an image feature obtained after a T^{th} round of denoising iteration being the image feature of the target image; and T being an integer greater than 1, and t being an integer greater than 0 and not greater than T.

Denoising may include the T rounds of denoising iterations. In the process of the t^{th} round of denoising iteration, the noise in the image feature inputted in the t^{th} round of denoising iteration is predicted by using the trained text-to-image generation model based on the target condition feature, and the predicted noise is removed from the image feature inputted in the t^{th} round of denoising iteration, to obtain the image feature to be inputted in the (t+1)^{th} round of denoising iteration.

In some embodiments, the text-to-image generation model includes a feature cross network. The performing denoising on the image feature of the random noise image based on the target condition feature by using the text-to-image generation model, to obtain an image feature of the target image may be implemented in such a manner: performing feature crossing on the target condition feature and the image feature of the random noise image by using the feature cross network, to predict and remove noise in the image feature of the random noise image, to obtain the image feature of the target image.

In a case that the text-to-image generation model includes the feature cross network, the model training phase of the text-to-image generation model refers to training of the feature cross network. In the model inference phase of the text-to-image generation model, feature crossing is performed on the target condition feature and the image feature of the random noise image by using the trained feature cross network, to predict and remove the noise in the image feature of the random noise image, to obtain the image feature of the target image.

If the denoising process includes the T^{th} round of denoising iterations, in the process of the t^{th} round of denoising iteration, feature crossing is performed, by using the trained feature cross network, on the target condition feature and the image feature inputted in the t^{th} round of denoising iteration, to predict and remove the noise in the image feature inputted in the t^{th} round of denoising iteration, to obtain the image feature to be inputted in the (t+1)^{th} round of denoising iteration.

As shown in FIG. 6, in some embodiments, after the text-to-image generation model is trained, a user only may input prompt information, and automatic image generation can be implemented by using the trained text-to-image generation model. In addition, input of an image modality and a text modality can be supported, whereby flexibility is high, and various image generation requirements can be met.

The following describes exemplary application of some embodiments in an actual application scenario. In some embodiments, single-modal training of a LoRA model driven by only an image may be implemented, to breaks dependency on image-text pairs. The LoRA model can be trained based on only image data. In addition, an image includes more details than text. In some embodiments, training of the LoRA model is guided based on rich semantic information included in the image, which can maximally preserve original capabilities of the text-to-image generation model, and reduce adverse effects of training based on image-text pairs on original model parameters of the text-to-image generation model.

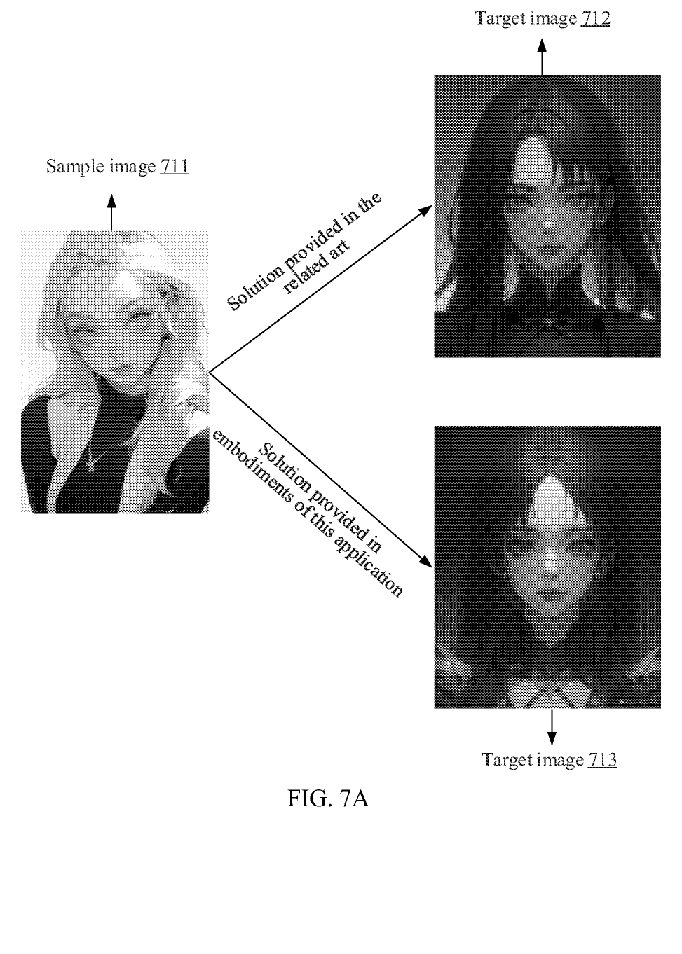

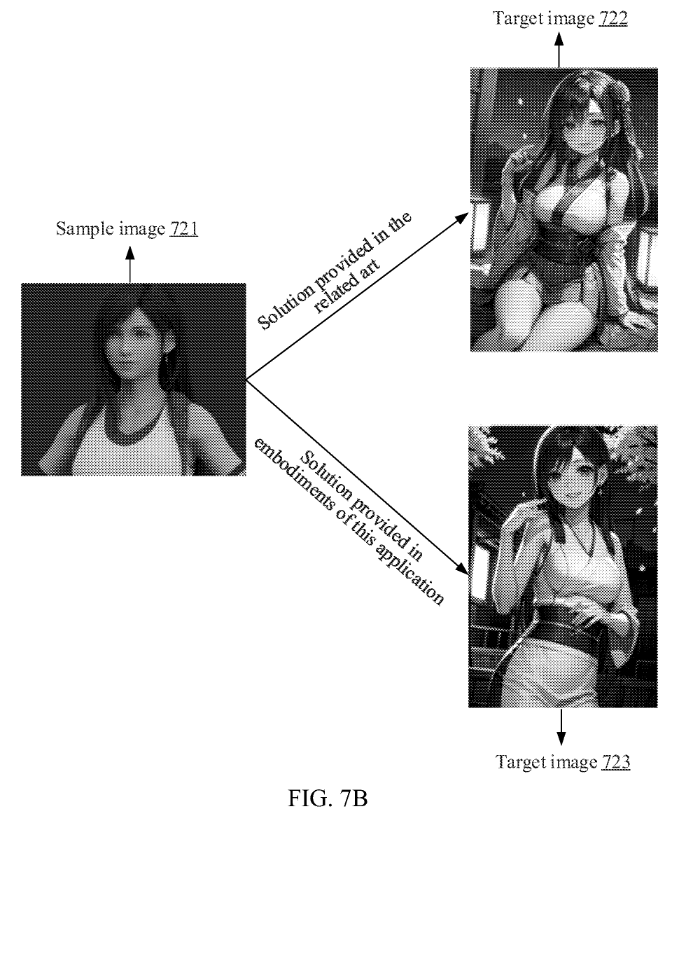

Training methods for the LoRA model are used as an example. Some embodiments provide a schematic comparison diagram of style binding shown in FIG. 7A. FIG. 7A shows a target image 712 generated by a text-to-image generation model (for example, a base model + a trained LoRA model) trained according to the solution provided in the related art, and further shows a target image 713 generated by a text-to-image generation model (for example, a base model + a trained LoRA model) trained according to the solution provided in some embodiments. Prompt information configured for generating the target image 712 is the same as prompt information configured for generating the target image 713. In addition, one sample image 711 in a training data set of the LoRA model (or referred to as a training data set of a text-to-image generation model) is exemplarily shown. All sample images in the training data set have a same style. Therefore, a process of training the LoRA model is also a style binding process. In the process of training the LoRA model according to the solution provided in some embodiments and the process of training the LoRA model according to the solution provided in the related art, a same sample image is used. However, in the solution provided in the related art, sample text corresponding to the sample image is further used.

Some embodiments further provide a schematic comparison diagram of object binding shown in FIG. 7B. FIG. 7B shows a target image 722 generated by a text-to-image generation model (for example, a base model + a trained LoRA model) trained according to the solution provided in the related art, and further shows a target image 723 generated by a text-to-image generation model (for example, a base model + a trained LoRA model) trained according to the solution provided in some embodiments. Prompt information configured for generating the target image 722 is the same as prompt information configured for generating the target image 723. In addition, one sample image 721 in a training data set of the LoRA model is exemplarily shown. All sample images in the training data set include a same object (for example, a game character in the sample image 721). Therefore, a process of training the LoRA model is also an object binding process.

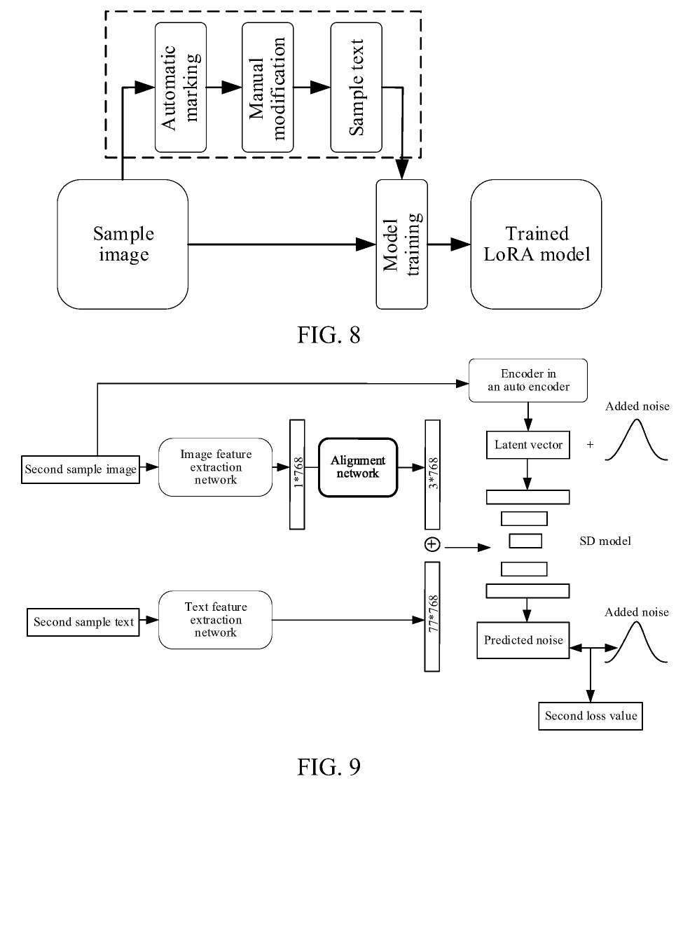

It may be determined based on FIG. 7A and FIG. 7B that, compared with the solution provided in the related technology, some embodiments can shorten a link for training the LoRA model while ensuring a good image generation effect, which avoids manual intervention in the training procedure, and can establish a standard automatic LoRA training procedure for different IDs. As shown in FIG. 8, some embodiments avoid a process of implementing text annotation through an operation such as automatic marking or manual modification in the solution provided in the related art.

Next, the solution provided in some embodiments is described in detail.

In some embodiments, a pre-trained text-to-image generation model and a multi-modal model are used. A type of the text-to-image generation model is not limited. An SD model (an Unet network in the SD model) is used as an example herein. A type of the multi-modal model is also not limited, and the multi-modal model may include an image feature extraction network and a text feature extraction network. A CLIP model is used as an example herein.

The SD model is a latent space-based conditional diffusion model. The SD model encodes an image into a Latent variable through an encoder in an AE, then introduces a condition (referring to a text feature in text feature space) through a diffusion model, converts the latent variable obtained through encoding by the encoder into another latent variable, and finally restores the latent variable obtained through conversion into an image through a decoder of the AE. A condition feature of the SD model is a text feature. The text feature is obtained by performing text feature extraction by using a text feature extraction network of CLIP. For example, the SD model encodes text into text features of 77*768 dimensions by using a text feature extraction network in a CLIP ViT-L model, and introduces the text features into Latent by using a cross attention mechanism (corresponding to the foregoing feature cross network).

The CLIP model is a multi-modal model that is pre-trained based on image-text pairs through comparison learning, and mainly includes an image feature extraction network and a text feature extraction network. The image feature extraction network is also referred to as an image encoder, and the text feature extraction network is also referred to as a text encoder.

Based on the foregoing premise, the training process in some embodiments may be divided into three phases, which are respectively described below.

1) Training of an alignment network.

In some embodiments, the SD model is used as a base model. The SD model generates an image by using text features in text feature space as a condition. Therefore, when the LoRA model is trained, features in the text feature space also need to be used as a condition for guidance. Therefore, to implement image driving, an alignment network is designed to align an image feature into the text feature space.

The alignment network may be a lightweight network including a Linear layer and a LayerNorm layer. The alignment network may be trained based on large-scale open-source image-text pairs. A training process is shown in FIG. 9. For example, a text feature of second sample text are extracted by using the text encoder in the CLIP ViT-L model, and the text feature has a dimension of 77*768 (which may be considered as 77 tokens). Meanwhile, a first image feature of a second sample image are extracted by using the image encoder in the CLIP ViT-L model, and the first image feature of the second sample image has a dimension of 1*768. Subsequently, the first image feature of the second sample image is converted into the text feature space by using the alignment network, and the dimension is expanded to 3*768, to enable the model to perceive a feature with a finer granularity. In this way, a second image feature of the second sample image can be obtained. Finally, the second image feature of the second sample image and the text feature of the second sample text are concatenated into a second sample condition feature having a dimension of 80*768, to guide the SD model to perform image generation.

In a training phase of the alignment network, all networks except the alignment network are frozen, for example, model parameters of all networks except the alignment network are kept unchanged. Adam may be used as a training optimizer, a large learning rate (such as 1e-4) is employed, whereby the randomly initialized alignment network can quickly learn how to accurately align the first image feature into the text feature space. The alignment network may be trained based on large-scale open-source image-text pair data, to enable the trained alignment network to robustly convert a first image feature of any image.

2) Training of an embedded image feature (Image Inversion).

After the alignment network is trained, Image Inversion may be introduced into the text feature space for storing commonality of data, to implement ID binding. Image Inversion may have a dimension of 3*768. This is not limited herein. Herein, all or a part of the training data set of the LoRA model may be used as a training data set of Image Inversion. The training data set of the LoRA model includes a plurality of first sample images, and the plurality of first sample images have a same ID.

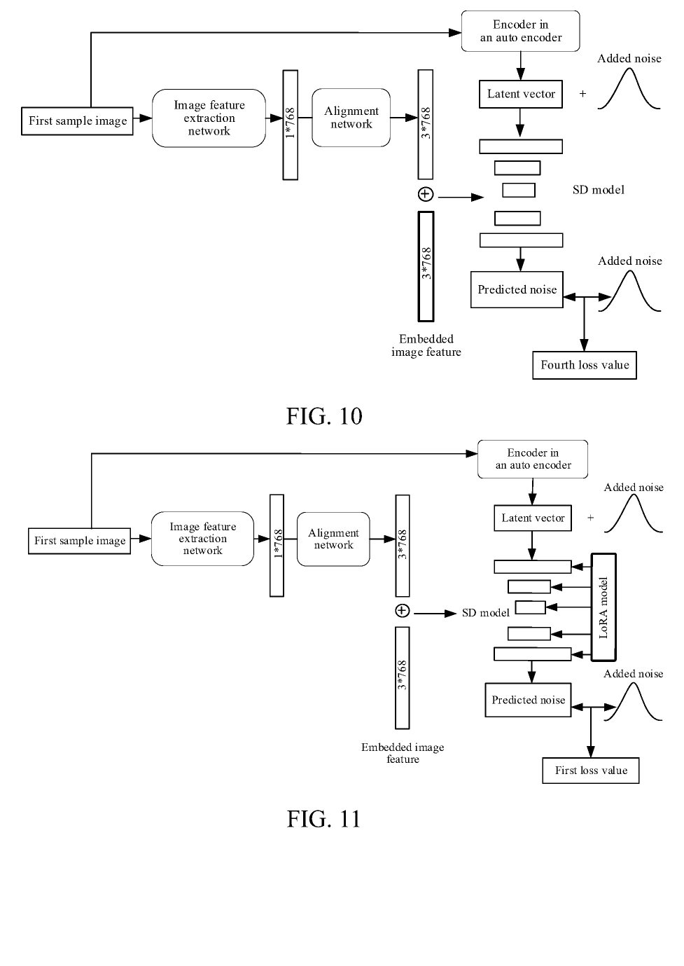

First, Image Inversion may be randomly initialized. As shown in FIG. 10, in a training phase of Image Inversion, the first image feature of the first sample image is aligned into the text feature space by using the trained alignment network, to obtain the second image feature of the first sample image. Then, the second image feature of the first sample image and the Image Inversion are concatenated into the third sample condition feature of 6*768, to guide the SD model to perform image generation.

Similarly, in the training phase of the Image Inversion, all model parameters except Image Inversion are kept unchanged.

3) Training of a LoRA model.

After the alignment network and Image Inversion are trained, the LoRA model enters a model training phase. As shown in FIG. 11, the first image feature of the first sample image is aligned into the text feature space by using the trained alignment network, to obtain the second image feature of the first sample image, and then the second image feature of the first sample image and the trained Image Inversion are concatenated into the first sample condition feature of 6*768, to guide the text-to-image generation model (the SD model + the LoRA model) to perform image generation.

Similarly, in a training phase of the LoRA model, all networks except the LoRA model are frozen.

After the foregoing three training phase are completed, a model inference phase may proceed based on the trained alignment network, trained Image Inversion, and the trained text-to-image generation model (the SD model + the trained LoRA model). The model inference phase may include the following operations:
1) Obtain prompt information inputted by a user.
2) Perform prompt feature extraction on the prompt information, to obtain a prompt feature that is of the prompt information and that is aligned into text feature space, and generate a target condition feature based on the prompt feature of the prompt information.

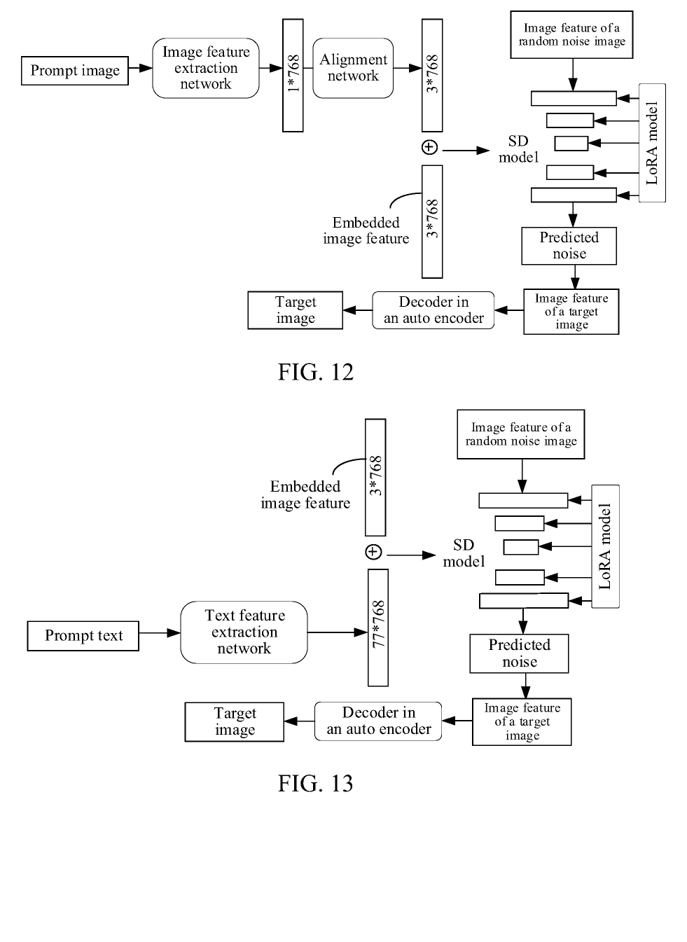

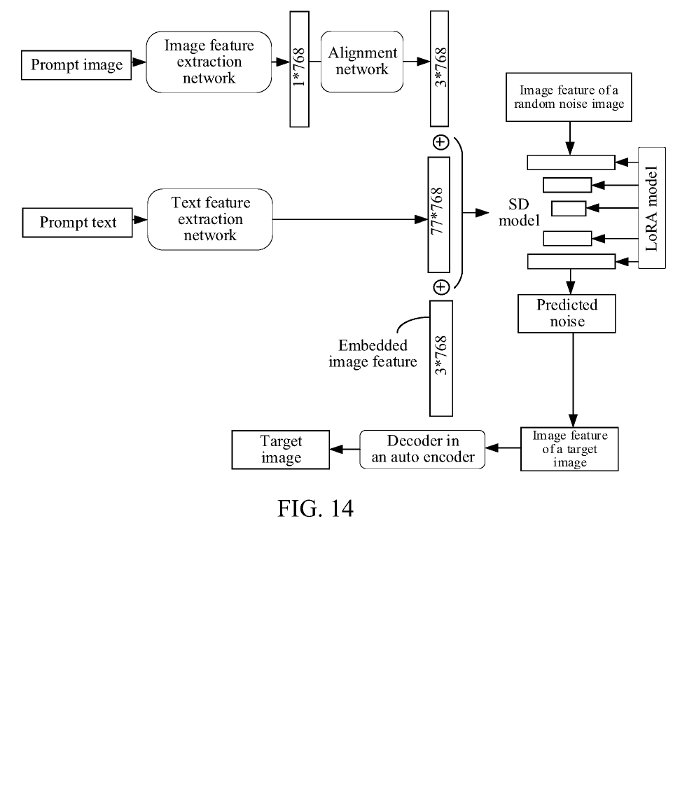

According to different modalities of the prompt information, operation 2) may include the following cases:
1. As shown in FIG. 12, perform, when the prompt information is a prompt image, image feature extraction on the prompt image by using the image encoder, to obtain a first image feature (whose dimension is 1*768) of the prompt image, then, align the first image feature of the prompt image into the text feature space by using the trained alignment network, to obtain a second image feature (whose dimension is 3*768) of the prompt image, and concatenate the second image feature of the prompt image and trained Image Inversion into a target condition feature of 6*768.
2. As shown in FIG. 13, perform, when the prompt information is prompt text, text feature extraction on the prompt text by using the text encoder, to obtain a text feature (whose dimension is 77*768) of the prompt text, and then concatenate the text feature of the prompt text and trained Image Inversion into a target condition feature of 80*768.
3. As shown in FIG. 14, perform, when the prompt information includes both the prompt image and the prompt text, image feature extraction on the prompt image by using the image encoder, to obtain the first image feature (whose dimension is 1*768) of the prompt image, and then align the first image feature of the prompt image into the text feature space by using the trained alignment network, to obtain the second image feature (whose dimension is 3*768) of the prompt image; and perform text feature extraction on the prompt text by using the text encoder, to obtain the text feature (whose dimension is 77*768) of the prompt text. Then, the second image feature of the prompt image, the text feature of the prompt text, and trained Image Inversion are concatenated into the target condition feature of 83 * 768.

3) Guide the trained text-to-image generation model to perform image generation based on the target condition feature, to obtain a target image.

The following describes an exemplary structure of an AI-based text-to-image generation model training apparatus 255 that is provided in some embodiments and that is implemented as a software module. In some embodiments, as shown in FIG. 2, software modules in the AI-based text-to-image generation model training apparatus 255 stored in the memory 250 may include: a first obtaining module 2551, configured to obtain a sample image; a first feature extraction module 2552, configured to perform image feature extraction on the sample image, to obtain a first image feature of the sample image; a first alignment module 2553, configured to align the first image feature of the sample image into text feature space, to obtain a second image feature of the sample image; a first prediction module 2554, configured to perform image generation based on the second image feature of the sample image, to obtain a prediction result; and a training module 2555, configured to perform model training based on the prediction result, to obtain a text-to-image generation model.

In some embodiments, the text-to-image generation model training apparatus 255 further includes a first generation module. The first generation module is configured to determine a sample condition feature based on the second image feature of the sample image.

The first prediction module 2554 is configured to perform image generation based on the sample condition feature, to obtain the prediction result.

In some embodiments, the training module 2555 is further configured to determine a loss value based on the prediction result, and perform model training based on the loss value, to obtain the text-to-image generation model.

In some embodiments, the sample image includes at least one of a first sample image, a second sample image, and a third sample image, the first sample image is configured for training the text-to-image generation model, the second sample image is configured for training an alignment network, the alignment network is configured for aligning a first image feature of the first sample image into the text feature space, the third sample image is configured for training a multi-modal model, and the multi-modal model is configured to extract the first image feature of the first sample image.

The sample condition feature includes at least one of a first sample condition feature, a second sample condition feature, and a third sample condition feature, the prediction result includes at least one of a first prediction result, a second prediction result, and a third prediction result, and the loss value includes at least one of a first loss value, a second loss value, and a third loss value.

In some embodiments, the training module 2555 includes a text-to-image generation model training module and an alignment network training module. The first alignment module 2553 is further configured to: obtain second sample text corresponding to the second sample image, and extract a text feature of the second sample text; align the first image feature of the first sample image into the text feature space by using the alignment network, to obtain a second image feature of the first sample image; and align a first image feature of the second sample image into the text feature space by using the alignment network, to obtain a second image feature of the second sample image.

The first generation module is further configured to determine the first sample condition feature based on the second image feature of the first sample image, and perform feature fusion on the second image feature of the second sample image and the text feature of the second sample text, to obtain the second sample condition feature.

The text-to-image generation model training module is configured to train a to-be-trained text-to-image generation model based on the first loss value.

The alignment network training module is configured to train the alignment network based on the second loss value, the trained alignment network being configured for aligning the first image feature of the first sample image into the text feature space, to obtain the second image feature of the first sample image.

In some embodiments, the AI-based text-to-image generation model training apparatus 255 further includes a multi-modal model training module, configured to: obtain a plurality of third sample images and third sample text respectively corresponding to the plurality of third sample images; extract a first image feature of each third sample image by using an image feature extraction network in the multi-modal model; extract a text feature of each third sample text by using a text feature extraction network in the multi-modal model; determine a feature extraction loss value based on the first image feature of each third sample image and the text feature of each third sample text, and train the multi-modal model based on the feature extraction loss value, the image feature extraction network in the trained multi-modal model being configured for performing image feature extraction on the second sample image and the first sample image; and the text feature extraction network in the trained multi-modal model being configured for performing text feature extraction on the second sample text.

In some embodiments, the first sample condition feature includes at least one of the second image feature of the first sample image and an image fusion feature, and the image fusion feature is obtained by fusing the second image feature of the first sample image with an embedded image feature in the text feature space.

In some embodiments, the first prediction module 2554 is further configured to perform any one of the following processing: performing feature fusion on the second image feature of the first sample image and the embedded image feature in the text feature space, to obtain the first sample condition feature; or determine the second image feature of the first sample image as the first sample condition feature.

In some embodiments, the AI-based text-to-image generation model training apparatus 255 further includes an embedded image feature training module, configured to: initialize the embedded image feature in the text feature space; and perform feature fusion on the second image feature of the first sample image and the embedded image feature, to obtain the third sample condition feature; and guide the text-to-image generation model to perform image generation based on the third sample condition feature, determine the third loss value based on the third prediction result generated in the image generation process, and update the embedded image feature based on the third loss value.

In some embodiments, a plurality of first sample images are included. The AI-based text-to-image generation model training apparatus 255 further includes an embedded image feature determination module, configured to determine a second image feature of any first sample image as the embedded image feature.

In some embodiments, the training module 2555 is further configured to learn an incremental parameter based on the loss value, and update a model parameter of the to-be-trained text-to-image generation model based on the incremental parameter, to obtain the text-to-image generation model, a dimension of the incremental parameter being the same as a dimension of the model parameter.

In some embodiments, the training module 2555 is further configured to perform any one of the following processing: learning a first sub-incremental parameter and a second sub-incremental parameter based on the first loss value, performing parameter fusion on the first sub-incremental parameter and the second sub-incremental parameter to obtain an incremental parameter, and updating a model parameter of the text-to-image generation model based on the incremental parameter; or learning the incremental parameter based on the first loss value, and updating the model parameter of the text-to-image generation model based on the incremental parameter, the dimension of the incremental parameter being the same as the dimension of the model parameter.

In some embodiments, the first prediction result includes predicted noise. The training module 2555 is further configured to: map the first sample image from pixel space to latent space, to obtain a third image feature of the first sample image; add noise to the third image feature of the first sample image, to obtain a noised image feature; perform noise extraction on the noised image feature based on the first sample condition feature, to obtain the predicted noise; and us a difference between the added noise and the predicted noise as the first loss value.

The following describes an exemplary structure of an AI-based image generation apparatus 455 that is provided in some embodiments and that is implemented as a software module. In some embodiments, as shown in FIG. 3, software modules in the AI-based image generation apparatus 455 stored in the memory 450 may include: a second obtaining module 4551, configured to obtain prompt information; a second feature extraction module 4552, configured to perform prompt feature extraction on the prompt information, to obtain a prompt feature that is of the prompt information and that is aligned into text feature space; a second generation module 4553, configured to determine a target condition feature based on the prompt feature of the prompt information; and a second prediction module 4554, configured to guide a text-to-image generation model to perform image generation based on the target condition feature, to obtain a target image, the text-to-image generation model being obtained through training by using an AI-based text-to-image generation model training method.

In some embodiments, the second feature extraction module 4552 is further configured to: extract a first image feature of a prompt image when the prompt information is the prompt image, and use a second image feature obtained by aligning the first image feature of the prompt image into the text feature space as the prompt feature; extract, when the prompt information is prompt text, a text feature of the prompt text as the prompt feature; or perform feature fusion on the second image feature of the prompt image and the text feature of the prompt text when the prompt information includes the prompt image and the prompt text, to obtain the prompt feature.

In some embodiments, the target condition feature includes at least one of the prompt feature of the prompt information and a target fusion feature. The target fusion feature is obtained by fusing the prompt feature of the prompt information with an embedded image feature in the text feature space.

In some embodiments, the second generation module 4553 is further configured to perform any one of the following processing: performing feature fusion on the prompt feature of the prompt information and the embedded image feature in the text feature space, to obtain the target condition feature; or determining the prompt feature of the prompt information as the target condition feature.

In some embodiments, the second prediction module 4554 is further configured to: generate an image feature of a random noise image in latent space; perform denoising on the image feature of the random noise image based on the target condition feature by using the text-to-image generation model, to obtain the image feature of the target image; and map the image feature of the target image from the latent space to pixel space, to obtain the target image.

Some embodiments provide a computer program product or a computer program. The computer program product or the computer program includes executable instructions. The executable instructions are stored in a computer-readable storage medium. A processor of an electronic device reads the executable instructions from the computer-readable storage medium, and executes the executable instructions, to cause the electronic device to perform the AI-based text-to-image generation model training method and the AI-based image generation method according to the foregoing embodiments of this application.

Some embodiments provide a computer-readable storage medium having executable instructions stored therein. The executable instructions, when executed by a processor, cause the processor to perform the AI-based text-to-image generation model training method and the AI-based image generation method according to some embodiments.

In some embodiments, the computer-readable storage medium may be a memory such as a ferroelectric RAM (FRAM), a ROM, a programmable ROM (PROM), an erasable PROM (EPROM), an electrically EPROM (EEPROM), a flash memory, a magnetic surface memory, an optical disk, or a compact disc-ROM (CD-ROM); or may be any device including one of or any combination of the foregoing memories.

In some embodiments, the executable instructions may take the form of a program, software, a software module, a script, or code, written in any form of programming language (including compiled or interpreted languages, or declarative or procedural languages), and may be deployed in any form, including as a stand-alone program or as a module, component, subroutine, or another unit suitable for use in a computing environment.

For example, the executable instructions may, but do not necessarily, correspond to a file in a file system, and may be stored in a part of a file that saves another program or data, for example, be stored in one or more scripts in a hypertext markup language (HTML) file, stored in a file that is specially configured for a program in discussion, or stored in a plurality of collaborative files (for example, be stored in files of one or modules, subprograms, or code parts).

For example, the executable instructions may be deployed to be executed on one computer device, or executed on a plurality of computer devices located at one position, or executed on a plurality of computer devices that are distributed in a plurality of positions and that are interconnected by a communication network.

The technical features of the foregoing embodiments may be combined in different manners to form other embodiments. To make description concise, not all possible combinations of the technical features in the foregoing embodiments are described. However, the combinations of these technical features are considered as falling within the scope recorded by this description provided that no conflict exists.

The foregoing embodiments only describe several implementations of this application, which are described specifically and in detail, but cannot be construed as a limitation on the patent scope of this application. Fr a person of skill in the art, several transformations and improvements can be made without departing from the idea of this application, and these transformations and improvements fall within the protection scope of this application. Therefore, the protection scope of the patent of this application are subject to the appended claims.

What is claimed is:

1. An artificial intelligence (AI)-based text-to-image generation model training method, performed by a computer device, the method comprising: obtaining a sample image; extracting a first image feature from the sample image; aligning the first image feature into a text feature space to obtain a second image feature of the sample image; generating an image based on the second image feature, to obtain a prediction result; and training a text-to-image generation model based on the prediction result.

2. The method according to claim 1, wherein the generating comprises: determining a sample condition feature based on the second image feature; and generating the image based on the sample condition feature to obtain the prediction result.

3. The method according to claim 2, wherein the training comprises: determining a loss value based on the prediction result; and training the text-to-image generation model based on the loss value.

4. The method according to claim 3, wherein the sample image comprises at least one of: a first sample image for training the text-to-image generation model,
a second sample image for training an alignment network, or a third sample image for training a multi-modal model; wherein the alignment network is configured for aligning a first image feature of the first sample image into the text feature space, the multi-modal model is configured to extract the first image feature of the first sample image; and wherein the sample condition feature comprises at least one of: a first sample condition feature, a second sample condition feature, or a third sample condition feature; wherein the prediction result comprises at least one of a first prediction result, a second prediction result, or a third prediction result; and wherein the loss value comprises at least one of a first loss value, a second loss value, or a third loss value.

5. The method according to claim 4, wherein the aligning comprises: obtaining a second sample text corresponding to the second sample image and extracting a text feature of the second sample text; aligning the first image feature of the first sample image into the text feature space via the alignment network to obtain a second image feature of the first sample image; and aligning the first image feature of the second sample image into the text feature space via the alignment network to obtain a second image feature of the second sample image; wherein the determining the sample condition feature comprises: determining the first sample condition feature based on the second image feature of the first sample image; and fusing the second image feature of the second sample image and the text feature of the second sample text to obtain the second sample condition feature; and wherein the training the text-to-image generation model comprises: training the text-to-image generation model based on the first loss value; and training the alignment network based on the second loss value, the trained alignment network being configured to align the first image feature of the first sample image into the text feature space to obtain the second image feature of the first sample image.

6. The method according to claim 5, further comprising: obtaining a plurality of third sample images and respective third sample text corresponding to the plurality of third sample images; and extracting a first image feature of each third sample image via an image feature extraction network in the multi-modal model;
extracting a text feature of each third sample text via a text feature extraction network in the multi-modal model; and determining a feature extraction loss value based on the first image feature of each third sample image and the text feature of each third sample text; and training the multi-modal model based on the feature extraction loss value, wherein the image feature extraction network in the trained multi-modal model is configured to perform image feature extraction on the second sample image and the first sample image, and the text feature extraction network in the trained multi-modal model is configured to perform text feature extraction on the second sample text.

7. The method according to claim 4, wherein the first sample condition feature comprises at least one of: the second image feature of the first sample image or an image fusion feature, the image fusion feature being obtained by fusing the second image feature of the first sample image with an embedded image feature in the text feature space.

8. The method according to claim 7, wherein the fusing comprises: initializing the embedded image feature in the text feature space; and fusing the second image feature of the first sample image and the embedded image feature to obtain the third sample condition feature; and wherein the training the text-to-image generation model comprises: determining the third loss value based on the third prediction result; and updating the embedded image feature based on the third loss value; and training the text-to-image generation model based on the first loss value.

9. The method according to claim 7, wherein the sample image comprises a plurality of first sample images, and wherein the embedded image feature comprises the second image feature of any one of the plurality of first sample images.

10. The method according to claim 3, wherein the training the text-to-image generation model comprises: learning an incremental parameter based on the loss value; and updating a model parameter of the text-to-image generation model based on the incremental parameter, wherein a dimension of the incremental parameter is the same as a dimension of the model parameter.

11. The method according to claim 4, wherein the first prediction result comprises predicted noise; and wherein the determining the loss value comprises: mapping the first sample image from a pixel space to a latent space to obtain a third image feature of the first sample image; adding noise to the third image feature to obtain a noised image feature; extracting noise from the noised image feature based on the first sample condition feature to obtain the predicted noise; and determining the first loss value as a difference between the added noise and the predicted noise.

12. An artificial intelligence (AI)-based text-to-image generation model training apparatus, comprising: at least one memory configured to store program code; and at least one processor configured to read the program code and operate as instructed by the program code, the program code comprising: obtaining code configured to cause at least one of the at least one processor to obtain a sample image; extracting code configured to cause at least one of the at least one processor to extract a first image feature from the sample image; aligning code configured to cause at least one of the at least one processor to align the first image feature into a text feature space to obtain a second image feature of the sample image; generating code configured to cause at least one of the at least one processor to generate an image based on the second image feature, to obtain a prediction result; and training code configured to cause at least one of the at least one processor to train a text-to-image generation model based on the prediction result.

13. The apparatus according to claim 12, wherein the generating code is further configured to cause at least one of the at least one processor to: determine a sample condition feature based on the second image feature; and generate the image based on the sample condition feature to obtain the prediction result.

14. The apparatus according to claim 13, wherein the training code is further configured to cause at least one of the at least one processor to determine a loss value based on the prediction result; and train the text-to-image generation model based on the loss value.

15. The apparatus according to claim 14, wherein the sample image comprises at least one of: a first sample image for training the text-to-image generation model, a second sample image for training an alignment network, or a third sample image for training a multi-modal model; wherein the alignment network is configured for aligning a first image feature of the first sample image into the text feature space, the multi-modal model is configured to extract the first image feature of the first sample image; and wherein the sample condition feature comprises at least one of: a first sample condition feature, a second sample condition feature, or a third sample condition feature; wherein the prediction result comprises at least one of a first prediction result, a second prediction result, or a third prediction result; and wherein the loss value comprises at least one of a first loss value, a second loss value, or a third loss value.

16. The apparatus according to claim 15, wherein the aligning code is further configured to cause at least one of the at least one processor to: obtain a second sample text corresponding to the second sample image and extract a text feature of the second sample text; align the first image feature of the first sample image into the text feature space via the alignment network to obtain a second image feature of the first sample image; and align the first image feature of the second sample image into the text feature space via the alignment network to obtain a second image feature of the second sample image;
wherein the generating code is further configured to cause at least one of the at least one processor to: determine the first sample condition feature based on the second image feature of the first sample image; and fuse the second image feature of the second sample image and the text feature of the second sample text to obtain the second sample condition feature; and wherein the training code is further configured to cause at least one of the at least one processor to: train the text-to-image generation model based on the first loss value; and train the alignment network based on the second loss value, the trained alignment network being configured to align the first image feature of the first sample image into the text feature space to obtain the second image feature of the first sample image.

17. The apparatus according to claim 16, wherein the program code further comprises: multi-modal code configured to cause at least one of the at least one processor to obtain a plurality of third sample images and respective third sample text corresponding to the plurality of third sample images; and feature code configured to cause at least one of the at least one processor to extract a first image feature of each third sample image via an image feature extraction network in the multi-modal model; text code configured to cause at least one of the at least one processor to extract a text feature of each third sample text via a text feature extraction network in the multi-modal model; and loss code configured to cause at least one of the at least one processor to determine a feature extraction loss value based on the first image feature of each third sample image and the text feature of each third sample text; and wherein the training code is further configured to cause at least one of the at least one processor to train the multi-modal model based on the feature extraction loss value, wherein the image feature extraction network in the trained multi-modal model is configured to perform image feature extraction on the second sample image and the first sample image, and the text feature extraction network in the trained multi-modal model is configured to perform text feature extraction on the second sample text.

18. The apparatus according to claim 15, wherein the first sample condition feature comprises at least one of: the second image feature of the first sample image or an image fusion feature, the image fusion feature being obtained by fusing the second image feature of the first sample image with an embedded image feature in the text feature space.

19. The apparatus according to claim 18, wherein the generating code is further configured to cause at least one of the at least one processor to: initialize the embedded image feature in the text feature space; and fuse the second image feature of the first sample image and the embedded image feature to obtain the third sample condition feature; and wherein the training code is further configured to cause at least one of the at least one processor to: determine the third loss value based on the third prediction result; and update the embedded image feature based on the third loss value; and train the text-to-image generation model based on the first loss value.

20. A non-transitory computer-readable storage medium, storing computer code which, when executed by at least one processor, causes the at least one processor to at least: obtain a sample image; extract a first image feature from the sample image; align the first image feature into a text feature space to obtain a second image feature of the sample image; generate an image based on the second image feature, to obtain a prediction result; and train a text-to-image generation model based on the prediction result.
